(19) United States
(12) Patent Application Publication
(10) Pub. No.: US 2026/0313609 A1
(43) Pub. Date: Oct. 8, 2026

(54) METHOD AND APPARATUS FOR POSITIONING TERMINAL USING MULTI-ACCURACY IN WIRELESS COMMUNICATION SYSTEM

(71) Applicant: Samsung Electronics Co., Ltd., Gyeonggi-do (KR)

(72) Inventor: June HWANG, Gyeonggi-do (KR)

(21) Appl. No.: 19/483,906

(22) PCT Filed: May 10, 2024
(86) PCT No.: PCT/KR2024/006406

§ 371 Date: Nov. 12, 2025

(30) Foreign Application Priority Data
May 11, 2023 (KR) 10-2023-0060993

(51) Int. Cl. H04W 64/00; H04W 28/02

(52) U.S. Cl. CPC H04W 64/006; H04W 28/0226

(57) ABSTRACT

The disclosure relates to a 5G or 6G communication system for supporting a higher data transmission rate. Specifically, the present disclosure relates to a method performed by a terminal in a wireless communication system, the method comprising the steps of: receiving, from an LMF, a first message including information for positioning measurement for multiple QoS; sequentially performing measurement on the multiple QoS on the basis of the first message; and transmitting, to the LMF, a second message including a result of the measurement.

### PRIORITY

This application is a National Phase Entry of PCT International Application No. PCT/KR2024/006406, which was filed on Apr. 26, 2024, and claims priority to Korean Patent Application No. 10-2023-0060993, which was filed on May 15, 2023, the entire content of each of which is incorporated herein by reference.

### TECHNICAL FIELD

The present technology relates to an operation of a terminal and a base station in a wireless communication system. Specifically, the disclosure relates to a method and a device for deriving the location of a particular terminal.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As described above, with the development of mobile communication systems, it has become possible to provide a variety of services, and as a result, measures to effectively provide these services are required.

### DISCLOSURE

### Technical Problem

An embodiment of the disclosure is to provide an apparatus and a method capable of effectively providing services in a mobile communication system.

Specifically, an embodiment of the disclosure relates to a transmission method and procedure required when positioning of a particular terminal is performed, and is to describe a message transmission method required for each procedure and the detailed content of the message.

### Technical Solution

An embodiment of the disclosure provides a method for deriving the location of a particular terminal in a wireless communication system.

### Advantageous Effects

Embodiments set forth herein provide an apparatus and a method capable of effectively providing services in a mobile communication system. Specifically, an embodiment of the disclosure provides a method for obtaining the location of a random terminal in various conditions.

Advantageous effects obtainable from the disclosure may not be limited to the above-mentioned effects, and other effects which are not mentioned herein may be clearly understood from the following description by those skilled in the art to which the disclosure pertains.

### DESCRIPTION OF DRAWINGS

FIG. 1 illustrates a structure of a long term evolution (LTE) system according to an embodiment of the disclosure.

FIG. 2 illustrates a radio protocol structure of an LTE system according to an embodiment of the disclosure.

FIG. 3 illustrates a structure of a next-generation mobile communication system according to an embodiment of the disclosure.

FIG. 4 illustrates a radio protocol structure of a next-generation mobile communication system according to an embodiment of the disclosure.

FIG. 5 is a block diagram illustrating an internal structure of a UE according to an embodiment of the disclosure.

FIG. 6 is a block diagram illustrating a structure of a new radio (NR) base station according to an embodiment of the disclosure.

FIG. 7 illustrates a positioning operation in a radio access network (RAN) using a single quality-of-service (QoS) configuration according to an embodiment of the disclosure.

FIG. 8 illustrates a positioning operation according to an embodiment of the disclosure.

### MODE FOR INVENTION

Hereinafter, the operation principle of the disclosure will be described in detail in conjunction with the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. Moreover, based on determinations by those skilled in the art, the embodiments of the disclosure may also be applied to other communication systems through some modifications without significantly departing from the scope of the disclosure.

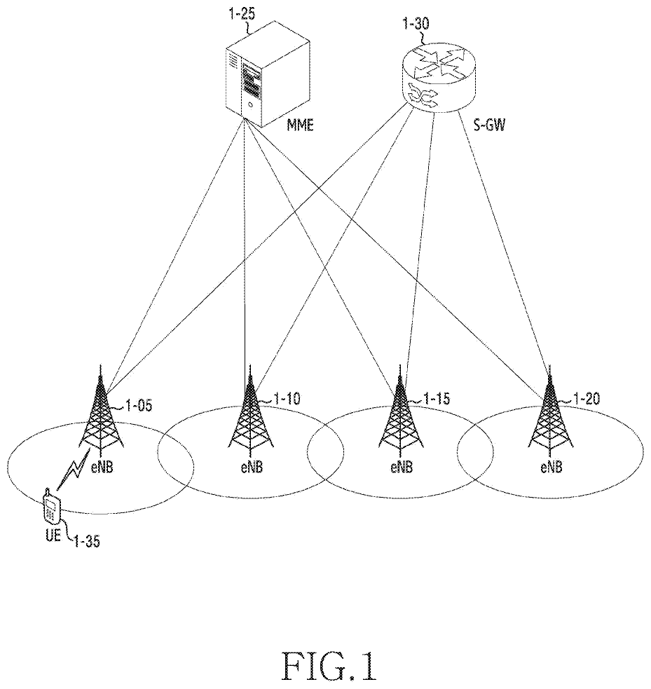

FIG. 1 illustrates a structure of a long term evolution (LTE) system according to an embodiment of the disclosure.

Referring to FIG. 1, as illustrated therein, a radio access network of an LTE system may include next-generation base stations (evolved node Bs, hereinafter ENBs, node Bs, or base stations) 1-05, 1-10, 1-15, and 1-20, a mobility management entity (MME) 1-25, and a serving gateway (S-GW) 1-30. A user equipment (hereinafter UE or terminal) 1-35 may access an external network through the ENBs 1-05 to 1-20 and the S-GW 1-30.

In FIG. 1, the ENBs 1-05 to 1-20 may correspond to conventional node Bs of a universal mobile telecommunication system (UMTS). The ENBs may be connected to the UE 1-35 through a radio channel, and perform more complicated roles than the conventional node Bs. In the LTE system, since all user traffic including real-time services, such as voice over IP (VOIP) via the Internet protocol, may be serviced through a shared channel. Thus, a device that collects state information, such as buffer statuses, available transmit power states, and channel states of UEs, and performs scheduling accordingly may be required, and the ENBs 1-05 to 1-20 may serve as the device. In general, one ENB may control multiple cells. For example, in order to implement a transfer rate of 100 Mbps, the LTE system may use orthogonal frequency division multiplexing (OFDM) as a radio access technology in a bandwidth of, for example, 20 MHz. Of course, the disclosure is not limited to the example above. Furthermore, according to an embodiment of the disclosure, the next-generation mobile communication system may employ an adaptive modulation & coding (hereinafter referred to as AMC) scheme for determining a modulation scheme and a channel coding rate according to a channel state of a UE. The S-GW 1-30 is a device that provides a data bearer, and may generate or remove a data bearer under the control of the MME 1-25. The MME is a device responsible for various control functions as well as a mobility management function for a UE, and may be connected to multiple base stations.

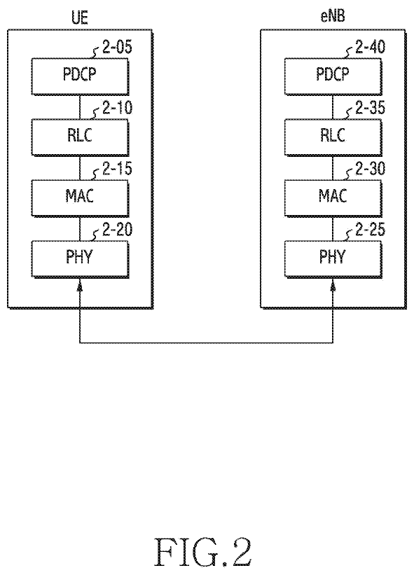

FIG. 2 illustrates a radio protocol structure of an LTE system according to an embodiment of the disclosure.

Referring to FIG. 2, a radio protocol of an LTE system may include a packet data convergence protocol (PDCP) 2-05 or 2-40, a radio link control (RLC) 2-10 or 2-35, and a medium access control (MAC) 2-15 or 2-30 on each of UE and ENB sides. The PDCP may serve to perform operations such as IP header compression/reconstruction. The main functions of the PDCP may be summarized as follows. Obviously, the examples given below are not limiting.
Header compression and decompression: robust header compression (ROHC) only
Transfer of user data
In-sequence delivery of upper layer PDUs at PDCP re-establishment procedure for RLC AM
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (RLC) 2-10 or 2-35 may reconfigure a PDCP protocol data unit (PDU) into an appropriate size to perform an ARQ operation. The main functions of the RLC may be summarized as follows.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 may be connected to several RLC layer devices configured in a single terminal, and perform operations of multiplexing RLC PDUs into a MAC PDU and demultiplexing a MAC PDU into RLC PDUs. The main functions of the MAC are summarized as follows. Obviously, the examples given below are not limiting.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

A physical layer 2-20 or 2-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the examples given below are not limiting.

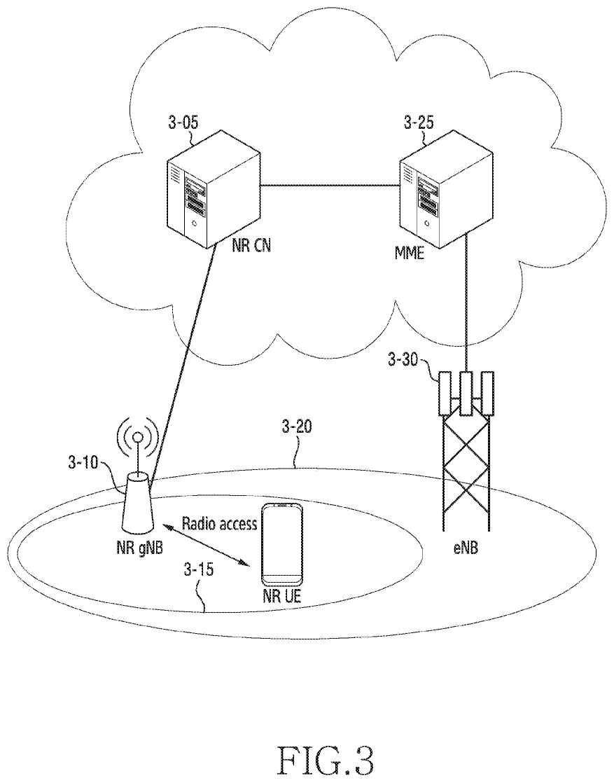

FIG. 3 illustrates a structure of a next-generation mobile communication system according to an embodiment of the disclosure.

Referring to FIG. 3, a radio access network of a next-generation mobile communication system (hereinafter NR or 5G) may include a new radio node B (hereinafter NR gNB or NR base station) 3-10, and a new radio core network (NR CN) 3-05. A new radio user equipment (NR UE or NR terminal) 3-15 may access an external network via the NR gNB 3-10 and the NR CN 3-05.

In FIG. 3, the NR gNB 3-10 may correspond to an evolved Node B (eNB) of a conventional LTE system. The NR gNB may be connected to the NR UE 3-15 through a radio channel and provide outstanding services as compared to a conventional node B. In the next-generation mobile communication system, since all user traffic may be serviced through a shared channel. Thus, a device that collects state information, such as buffer states, available transmit power states, and channel states of UEs, and performs scheduling accordingly is required, and the NR gNB 3-10 may serve as the device. In general, one NR gNB may control multiple cells.

According to an embodiment of the disclosure, in order to implement ultrahigh-speed data transfer beyond the current LTE, the next-generation mobile communication system may provide a wider bandwidth than the existing maximum bandwidth. In addition, according to an embodiment of the disclosure, the NR gNB 3-10 may employ an orthogonal frequency division multiplexing (OFDM) as a radio access technology, and may additionally integrate a beamforming technology therewith. Furthermore, according to an embodiment of the disclosure, the next-generation mobile communication system may employ an adaptive modulation & coding (hereinafter referred to as AMC) scheme for determining a modulation scheme and a channel coding rate according to a channel state of a UE. The NR CN 3-05 may perform functions such as mobility support, bearer configuration, and QoS configuration. The NR CN is a device responsible for various control functions as well as a mobility management function for a UE, and may be connected to multiple base stations. In addition, the next-generation mobile communication system may interwork with the existing LTE system, and the NR CN may be connected to an MME 3-25 via a network interface. The MME may be connected to an eNB 3-30 that is an LTE base station.

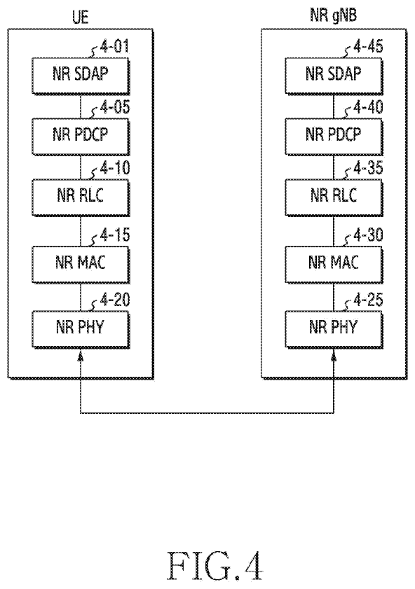

FIG. 4 illustrates a radio protocol structure of a next-generation mobile communication system according to an embodiment of the disclosure.

Referring to FIG. 4, a radio protocol of a next-generation mobile communication system may include an NR service data adaptation protocol (SDAP) 4-01 or 4-45, an NR PDCP 4-05 or 4-40, an NR RLC 4-10 or 4-35, an NR MAC 4-15 or 4-30, and an NR physical layer (PHY) 4-20 or 4-25 on each of UE and NR base station sides.

According to an embodiment of the disclosure, the main functions of the NR SDAP 4-01 or 4-45 may include at least one of functions below. Obviously, the examples given below are not limiting.
Transfer of user plane data
Mapping between a QoS flow and a DRB for both DL and UL
Marking QoS flow ID in both DL and UL packets
Reflective QoS flow to DRB mapping for UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

According to an embodiment of the disclosure, the main functions of the NR PDCP 4-05 or 4-40 may include at least one of functions below. Obviously, the example given below is not limiting.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

According to an embodiment of the disclosure, the reordering of the NR PDCP device may refer to a function of reordering PDCP PDU received from a lower layer in an order based on PDCP sequence numbers (SNs). The reordering of the NR PDCP device 4-05 or 4-40 may include at least one of a function of transferring data to an upper layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

According to an embodiment of the disclosure, the main functions of the NR RLC 4-10 or 4-35 may include some of functions below. Obviously, the examples given below are not limiting.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device may refer to a function of, if there is a lost RLC PDU, delivering only RLC SDUs before the lost RLC PDU to the upper layer in sequence. If one original RLC SDU is divided into several RLC SDUs and the RLC SDUs are received, the in-sequence delivery of the NR RLC device may include a function of reassembling the several RLC SDUs and transferring the reassembled RLC SDUs.

The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs.

The in-sequence delivery of the NR RLC device may refer to a function of, if there is a lost RLC PDU, delivering only RLC SDUs before the lost RLC PDU to the upper layer in sequence.

According to an embodiment of the disclosure, the in-sequence delivery of the NR RLC device may also include a function of, although there is a lost RLC SDU, if a predetermined timer has expired, sequentially transferring all the RLC SDUs received up to the current, to an upper layer.

According to an embodiment of the disclosure, the in-sequence delivery of the NR RLC device may also include a function of, although there is a lost RLC SDU, if a predetermined timer has expired, sequentially transferring all the RLC SDUs received up to the current, to an upper layer.

The NR RLC device may process RLC PDUs in a reception sequence, regardless of a sequence based on sequence numbers (out-of-sequence delivery). and then deliver the processed RLC PDUs to the NR PDCP device.

If receiving segments, the NR RLC device may receive segments stored in a buffer or to be received in the future, reconfigure the segments into one whole RLC PDU, process the RLC PDU, and then deliver the processed RLC PDU to the NR PDCP device.

According to an embodiment of the disclosure, the NR RLC layer may include no concatenation function, which may be performed in the NR MAC layer or replaced with a multiplexing function of the NR MAC layer.

According to an embodiment of the disclosure, the out-of-sequence delivery of the NR RLC device may include at least one of a function of directly delivering RLC SDUs received from a lower layer to an upper layer regardless of the order, a function of reassembling and delivering multiple RLC SDUs received, into which one original RLC SDU has been segmented, and a function of storing and reordering the RLC SNs or PDCP SNs of received RLC PDUs and recording lost RLC PDUs.

According to an embodiment of the disclosure, the NR MAC 4-15 or 4-30 may be connected to multiple NR RLC layer devices configured in one UE, and the main functions of the NR MAC may include at least one of functions below. Obviously, the examples given below are not limiting.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

According to an embodiment of the disclosure, the NR PHY layer 4-20 or 4-35 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the examples given above are not limiting.

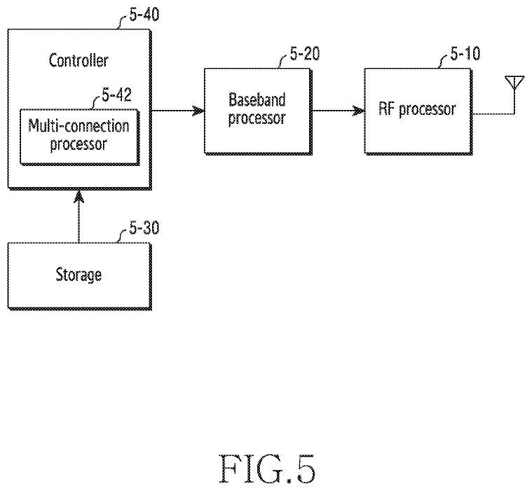

FIG. 5 is a block diagram illustrating a structure of a UE according to an embodiment of the disclosure.

Referring to FIG. 5, the UE may include a radio frequency (RF) processor 5-10, a baseband processor 5-20, a storage 5-30, and a controller 5-40. Of course, the example given above is not limiting, and the UE may include a smaller or larger number of components than the components illustrated in FIG. 5.

The RF processor 5-10 may perform a function for transmitting and receiving a signal via a wireless channel, such as band conversion and amplification of the signal. That is, the RF processor 5-10 may up-convert a baseband signal provided from the baseband processor 5-20 to an RF band signal, may transmit the same through an antenna, and may down-convert an RF band signal received through the antenna to a baseband signal. For example, the RF processor 5-10 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. In addition, the RF processor 5-10 may include multiple RF chains. Furthermore, the RF processor 5-10 may perform beamforming. For the beamforming, the RF processor 5-10 may adjust the phase and magnitude of each of signals transmitted and received through multiple antennas or antenna elements. In addition, the RF processor 5-10 may perform MIMO, and may receive multiple layers when performing MIMO operations.

The baseband processor 5-20 may perform functions of conversion between baseband signals and bitstrings according to the system's physical layer specifications. For example, during data transmission, the baseband processor 5-20 may encode and modulate a transmitted bitstring to generate complex symbols. In addition, during data reception, the baseband processor 5-20 may demodulate and decode a baseband signal provided from the RF processor 5-10 to restore a received bitstring. For example, when following the OFDM scheme, during data transmission, the baseband processor 5-20 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 5-20 may split a baseband signal provided from the RF processor 5-10 at the OFDM symbol level, may restore signals mapped to subcarriers through a fast Fourier transform (FFT) operation, and may restore a received bitstring through demodulation and decoding.

The baseband processor 5-20 and the RF processor 5-10 may transmit and receive signals as described above. Therefore, the baseband processor 5-20 and the RF processor 5-10 may be referred to as a transmitter, a receiver, a transceiver, or a communication unit. Furthermore, at least one of the baseband processor 5-20 and the RF processor 5-10 may include multiple communication modules to support multiple different radio access technologies. In addition, at least one of the baseband processor 5-20 and the RF processor 5-10 may include different communication modules to process signals in different frequency bands. For example, the different radio access technologies may include a wireless LAN (e.g., IEEE 802.11), a cellular network (e.g., LTE), and the like. In addition, the different frequency bands may include super high frequency (SHF) (e.g., 2NRHz) bands and millimeter wave (mmWave) (e.g., 60 GHz) bands. The UE may transmit and/or receive signals to and/or from the base station by using the baseband processor 5-20 and the RF processor 5-10, and the signals may include control information and data.

The storage 5-30 may store basic programs, application programs, and data, such as configuration information, for operation of the main base station. Particularly, the storage 5-30 may store information regarding a second access node configured to perform wireless communication by using a second radio access technology. In addition, the storage 5-30 may provide the stored data at the request of the controller 5-40. The storage 530 may include storage media such as a ROM, a RAM, a hard disk, a CD-ROM, and a DVD, or a combination of storage media. In addition, the storage 5-30 may be configured by multiple memories. According to an embodiment, the storage 5-30 may store programs for performing the above-described method for updating a flying path.

The controller 5-40 may control the overall operation of the UE. For example, the controller 5-40 may transmit and/or receive signals through the baseband processor 5-20 and the RF processor 5-10. In addition, the controller 5-40 records data in the storage 5-30 and reads the data from the storage 5-30. To this end, the controller 5-40 may include at least one processor. For example, the controller 5-40 may include a communication processor (CP) configured to perform control for communication, and an application processor (AP) configured to control upper layers such as application programs. In addition, at least one component in the UE may be implemented as a single chip. In addition, according to an embodiment of the disclosure, the controller 5-40 may include a multi-connection processor 5-42 configured to perform processing for operating in a multi-connection mode.

According to an embodiment of the disclosure, the controller 5-40 may control the components of the UE to perform a method for positioning a specific UE as described below. That is, the respective components of the UE may be operated to perform embodiments of the disclosure to be described below.

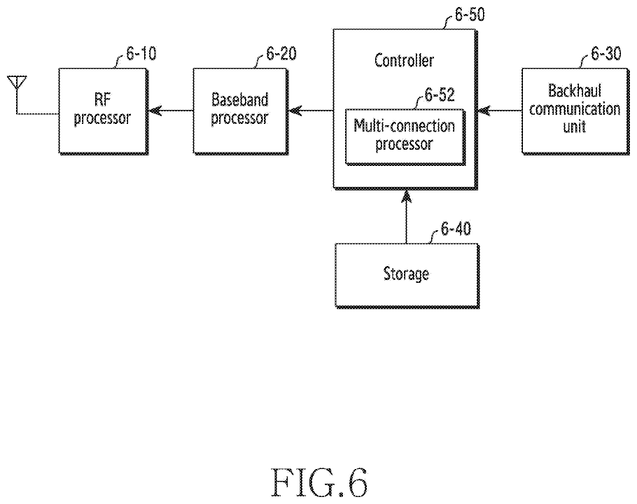

FIG. 6 is a block diagram illustrating a structure of an NR base station according to an embodiment of the disclosure.

Referring to FIG. 6, the base station may include an RF processor 6-10, a baseband processor 6-20, a backhaul communication unit 6-30, a storage unit 6-40, and a controller 6-50. Of course, the example given above is not limiting, and the base station may include a smaller or larger number of components than the components illustrated in FIG. 6.

The RF processor 6-10 may perform a function for transmitting and receiving a signal via a wireless channel, such as band conversion and amplification of the signal. The RF processor 6-10 may up-convert a baseband signal provided from the baseband processor 6-20 to an RF band signal, may transmit the same through an antenna, and may down-convert an RF band signal received through the antenna to a baseband signal. For example, the RF processor 6-10 may include a transmission filter, a reception filter, an amplifier, a mixer, an oscillator, a DAC, and an ADC. Although only one antenna is illustrated in the drawing, the first access node may include multiple antennas. In addition, the RF processor 6-10 may include multiple RF chains. Furthermore, the RF processor 6-10 may perform beamforming. For the beamforming, the RF processor 6-10 may adjust the phase and magnitude of signals transmitted and/or received through multiple antennas or antenna elements, respectively. The RF processor may transmit one or more layers to perform a downward MIMO operation.

The baseband processor 6-20 may perform functions of conversion between baseband signals and bitstrings according to the physical layer specifications of first radio access technology. For example, during data transmission, the baseband processor 6-20 may encode and modulate a transmitted bitstring to generate complex symbols. In addition, during data reception, the baseband processor 6-20 may demodulate and decode a baseband signal provided from the RF processor 6-10 to restore a received bitstring. For example, when following the OFDM scheme, during data transmission, the baseband processor 6-20 may encode and modulate a transmitted bitstring to generate complex symbols, may map the complex symbols to subcarriers, and may configure OFDM symbols through an IFFT operation and CP insertion. In addition, during data reception, the baseband processor 6-20 may split a baseband signal provided from the RF processor 6-10 at the OFDM symbol level, may restore signals mapped to subcarriers through FFT operation, and may restore a received bitstring through demodulation and decoding. The baseband processor 6-20 and the RF processor 6-10 may transmit and receive signals as described above. Therefore, the baseband processor 6-20 and the RF processor 6-10 may be referred to as a transmitter, a receiver, a transceiver, a communication unit, or a wireless communication unit. The base station may transmit/receive a signal with the UE by using the baseband processor 6-20 and the RF processor 6-10, and the signal may include control information and data.

The backhaul communication unit 6-30 may provide an interface for performing communication with other nodes within a network. The backhaul communication unit 6-30 may convert bitstrings transmitted from the main base station to other nodes, for example, auxiliary base stations or core networks, into physical signals, and may convert physical signals received from the other nodes into bitstrings.

The storage 6-40 may store basic programs, application programs, and data, such as configuration information, for operation of the main base station. In particular, the storage 6-40 may store information on bearers allocated to a connected UE, measurement results reported from the connected UE, and the like. In addition, the storage 6-40 may store information serving as a reference to determine whether to provide multi-connection to a UE or to suspend the same. In addition, the storage 6-40 may provide the stored data at the request of the controller 6-50. The storage 6-40 may provide the stored data at the request of the controller 6-50. The storage 6-40 may be configured by a storage media such as a ROM, a RAM, a hard disk, a CD-ROM, and a DVD, or a combination of storage media. In addition, the storage 6-40 may be configured by multiple memories. According to an embodiment, the storage 6-40 may store programs for performing the above-described method for altitude event-based measurement result reporting.

The controller 6-50 may control the overall operation of the base station. For example, the controller 6-50 may transmit/receive signals through the baseband processor 6-20 and the RF processor 6-10 or through the backhaul communication unit 6-30. In addition, the controller 6-50 records data in the storage 6-40 and reads the data from the storage 6-40. To this end, the controller 6-50 may include at least one processor. In addition, at least one component of the base station may be implemented as a single chip. In addition, the respective components of the base station may be operated to perform the above-described embodiments of the disclosure. In addition, according to an embodiment of the disclosure, the controller 6-50 may include a multi-connection processor 6-52 configured to perform processing for operating in a multi-connection mode.

The following definitions or conceptual relationships may be used with respect to QoS level, QoS accuracy, QoS class, and H-/V-accuracy mentioned in this patent.
QoS: This is a quality of service, and may represent, by using a quality, what level of accuracy a location (location estimate) obtained due to a positioning service of a specific UE has.
QoS accuracy: This may mean a specific numerical value of accuracy required in the concept of QoS. QoS may be used interchangeably with accuracy.
QoS level: A QoS may mean a level of accuracy required in the concept of QoS (having a relative meaning rather than the accuracy described below). This may be expressed as high or low, and may mean QoS having a specific accuracy value.
QoS class: A type of QoS required by an LCS client from an LMF. This may be classified into “assured,” “multiple QoS,” or “best effort.”
H-accuracy (value): This is horizontal accuracy, and a type of QoS accuracy. This value may consist of a horizontal location error value and an associated uncertainty value (e.g., accuracy: 3 m, uncertainty: 99% probability).
V-accuracy (value): This is vertical accuracy, and a type of QoS accuracy. This value may consist of a vertical location error value and an associated uncertainty value (e.g., accuracy: 4 m, uncertainty: 99% probability).
One QoS may be associated with H-accuracy and/or V-accuracy.
Each QoS or QoS level may be classified by an LMF as one of an accuracy level, a stringency level, or a preference level. When multiple QoSs are delivered to a UE through an LPP signal, each QoS may be classified as one of an accuracy level, a stringency level, or a preference level, and may be distinguished as the highest level, a middle level, or the lowest level. In this document, unless otherwise specified, accuracy, stringency, and preference are assumed to be presented in parallel.

In this patent, the expressions “satisfying a specific QoS,” “satisfying a specific QoS level,” and “satisfying a specific QoS accuracy” may be used with the same meaning, and may mean a case where a location estimate of a H-/V-accuracy associated with a specific QoS satisfies a given accuracy requirement for QoS (e.g., guaranteeing an error within 3 m with 99% probability for H-accuracy, and guaranteeing an error within 4 m with 98% probability for V-accuracy).

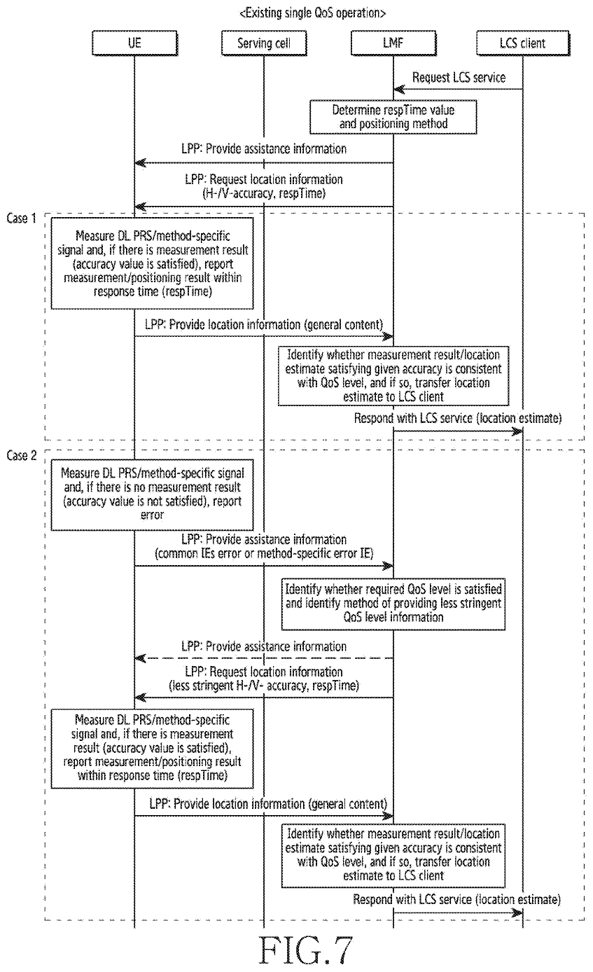

FIG. 7 is a diagram illustrating a positioning operation in a radio access network (RAN) using a single quality-of-service (QoS) configuration according to an embodiment of the disclosure.

Referring to FIG. 7, in a general positioning operation, a location management function (LMF) may receive, from a location service (LCS) client, an LCS service request. The LCS client may provide one piece of QoS information to the LMF, and request location information from the LMF, based on an indicated QoS level. A parameter transferred in this case may include at least one of a QoS class, a horizontal accuracy, a vertical accuracy, or a response time.

The LMF having received the information may determine an appropriate positioning method by considering received parameters. Then, the LMF may determine a response time value and transfer same to a target UE through an LPP RequestLocationInformation messages. In this case, assistance information may be transferred first.

The target UE having received information from the LMF may measure a downlink positioning reference signal (DL PRS) (if a RAT-dependent method is indicated) or a method-specific signal (if a RAT-independent method is indicated) and, if there is a measurement result satisfying an accuracy value of the QoS, may transmit, to the LMF, information including at least one of the measurement result or a location estimate based on the measurement result. The location estimate may be transferred within the pre-given response time through an LPP ProvideLocationInformation message.

The LMF having received the LPP ProvideLocationInformation message may identify whether the measurement result is consistent with the QoS level desired by the LMF. Afterwards, the LMF may transfer a location estimate corresponding to the measurement result to the LCS client.

If a result of the measurement by the UE does not satisfy the given QoS level, the UE may transmit an error message to the LMF. The error message may be indicated as a cause value of a common IE-related error in an LPP ProvideLocationInformation message, or may be indicated by an error message for each performed method. The LMF having received the error message may recognize that the desired QoS level fails to be satisfied, and may determine an accuracy value corresponding to a lower QoS level and request location information from the same UE again via LPP RequestLocationInformation. The UE having received the LPP RequestLocationInformation message may measure a DL PRS or a method-specific signal, and may determine whether the accuracy value corresponding to the given lower QoS level is satisfied.

If the accuracy value is satisfied, the UE may transmit a measurement result or a location estimate according to the result to the LMF. The LMF may check the measurement result and identify whether the measurement result satisfies the QoS level indicated by the LMF. The LMF may identify whether the measurement result satisfies the QoS level indicated by the LMF. Thereafter, if the measurement result satisfies the QoS level indicated by the LMF, the LMF may transmit a location estimate calculated from the measurement result (or directly received from the UE) to the LCS client.

Although FIG. 7 illustrates attempting a sequential LPP procedure, the multiple QoS levels are indicated at the same time regardless of conditions, so that the UE may attempt multiple procedures.

A method proposed in the disclosure may be used to reduce a signaling delay time caused by attempting a sequential LPP procedure, or to reduce unnecessary signals caused by multiple LPP procedures performed by a multiple QoS level indications. However, the disclosure is not limited to the example.

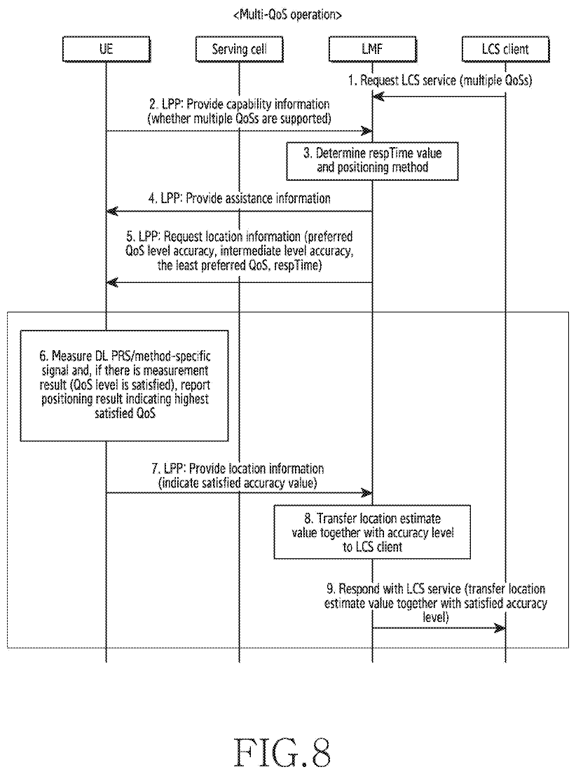

FIG. 8 is a diagram illustrating a positioning operation according to an embodiment of the disclosure.

Referring to FIG. 8, in stage 1, an LMF may receive an LCS service request from an LCS client. The LCS service request may include at least one of a multi-QoS class indicator, multiple accuracies according to the multi-QoS class indicator, or response time information. Based on the information included in the LCS service request, the LMF may specify a target UE and transfer an LPP Request Capability message to the specified target UE. The LPP Request Capability message may be a message for requesting UE capability information regarding positioning of the target UE. An indicator requesting whether there is a capability to process multiple QoSs may be included in the LPP Request Capability message.

In stage 2, before or after receiving the LCS service request, the LMF may receive positioning-related capability information from the UE that has received the LPP request capability message transferred in the above stage 1. In this case, an LPP Provide Capabilities message may be used. According to an embodiment of the disclosure, the LPP Provide Capabilities message may include an indicator indicating that processing of a multi-QoS-related operation is possible. However, the disclosure is not limited to the example below.

The target UE may indicate information on whether the UE is capable of processing multiple QoS classes, the information including at least one of the followings (Target UE can indicate on whether it can handle the multiple QoS class which includes at least:
Measurement of a location-related signal configured in LPP RequestLocationInformation (Measure the configured positioning related signal configured in LPP RequestLocationInformation)
Acquisition of a location estimate (Obtain the location estimate)
Evaluation of whether a resultant location estimate satisfies a relevant QoS accuracy (or QoS level) (Evaluate on whether the resulting location estimate is fulfilling the associated QoS accuracy (or QoS level))
The above operation is repeatable per QoS level (And the above operation can be repeated per QoS level)

A multi-QoS support indicator may be included in commonIEsProvideCapabilities and indicate that all cases are supportable regardless of a positioning method, or may be included in a ProvideCapabilities field of a particular positioning method and indicate that a multi-QoS operation is supportable only in a specific method.

An indicator requesting information regarding whether multiple QoSs are supportable in the LPP Request Capability message in stage 1 above may be expressed in a common field as follows. IEs may be described according to Table 1 below. However, the disclosure is not limited to the example below.

### 6.4.2 Common Positioning

### CommonIEsRequestCapabilities

CommonIEsRequestCabilities may transfer common IEs regarding a Request Capabilities LPP message Type (The CommonIEsRequestCapabilities carries common IEs for a Request Capabilities LPP message Type).

```
-- ASN1START
CommonIEsRequestCapabilities ::= SEQUENCE {
  ...,
  [[
  lpp-message-segmentation-req-r14 BIT STRING { serverToTarget (0),
```

| | |
|---|---|
| targetToServer (1) } | OPTIONAL - |

```
- Need ON
  ]],
  [[
```

| | |
|---|---|
| supportMultiQoS-req-r18 | NULL |

```
    OPTIONAL
  ]]
}
-- ASN1STOP
```

TABLE 1
CommonIEsRequestCapabilities field descriptions

lpp-message-segmentation-req
This field, if present, indicates that the target device is requested to provide its LPP
message segmentation capabilities.
If bit 0 is set to value 1, it indicates that the server is able to send segmented LPP
messages to the target device; if bit 0 is set to value 0 it indicates that the server is
not able to send segmented LPP messages to the target device.
If bit 1 is set to value 1, it indicates that the server is able to receive segmented LPP
messages from the target device; if bit 1 is set to value 0 it indicates that the server
is not able to receive segmented LPP messages from the target device.
supportMultiQoS-req
A supportMultiQoS-req field may request whether, when multiple QoSs are given
to the target UE, the UE supports reporting a QoS having the highest accuracy or
preference among satisfied QoSs (This field, if present, indicates that the target
device is requested to provide whether it supports reporting of achieved QoS level.)

In addition, an indicator indicating support of multiple QoSs included in the LPP Provide capability message in stage 2 above may be included in a common field as follows. IEs may be described according to Table 2 and Table 3 below. However, the disclosure is not limited to the example below.

### CommonIEsProvideCapabilities

CommonIEsProvideCapabilities may transfer common IEs regarding a Provide Capabilities LPP message Type (The CommonIEsProvideCapabilities carries common IEs for a Request Capabilities LPP message Type).

```
-- ASN1START
CommonIEsProvideCapabilities ::= SEQUENCE {
  ...,
  [[
```

| | |
|---|---|
| segmentationInfo-r14 | SegmentationInfo-r14 |
| OPTIONAL, | -- Cond Segmentation |
| lpp-message-segmentation-r14 | BIT STRING { serverToTarget (0), |
| targetToServer (1) } | OPTIONAL |

```
  ]],
  [[
```

| | |
|---|---|
| supportMultiQoS-r18 | ENUMERATED |
| {Yes} | OPTIONAL |

]]
}
-- ASN1STOP

TABLE 2

| Conditional | |
|---|---|
| presence | Explanation |
| Segmentation | This field is optionally present, need OP, if lpp-message- |
| | segmentation-req has been received from the location |
| | server with bit 1 (targetToServer) set to value 1. The |
| | field shall be omitted if lpp-message-segmentation-req |
| | has not been received in this location session, or has |
| | been received with bit 1 (targetToServer) set to value 0. |

TABLE 3
CommonIEsProvideCapabilities field descriptions

segmentationInfo
This field indicates whether this ProvideCapabilities message is one of many
segments, as specified in clause 4.3.5.
lpp-message-segmentation
This field, if present, indicates the target device's LPP message segmentation
capabilities.
If bit 0 is set to value 1, it indicates that the target device supports receiving
segmented LPP messages; if bit 0 is set to value 0 it indicates that the target device
does not support receiving segmented LPP messages.
If bit 1 is set to value 1, it indicates that the target device supports sending
segmented LPP messages; if bit 1 is set to value 0 it indicates that the target device
does not support sending segmented LPP messages.
supportMultiQoS
A supportMultiQoS field may indicate that, when multiple QoSs are given to the
target UE, the UE has a capability to report the highest satisfied QoS level (This
field, if present, indicates the target device's capability to report the achieved QoS
level when multiple QoS have been provided.)

In stage 3, the LMF may determine a positioning method by referring to at least one of the given accuracy values of the multiple QoSs, the response time, or the UE capability. In addition, the LMF may specify a target UE and determine a response time value specialized for the specified UE.

In stage 4, the LMF may transfer assistance information on the determined positioning method to the UE.

In stage 5, the LMF may determine a positioning method by using the UE capability information and information received from the LCS client, and may request the UE to perform a positioning procedure.

When a multi-QoS support indicator is included and transferred to the LMF, the LMF may indicate the positioning procedure to the UE, including accuracy information of the multiple QoSs. If the multi-QoS support indicator is included in the common field, the LMF may indicate a positioning procedure to the UE for any positioning method. Alternatively, if the multi-QoS support indicator is included in a field of a specific positioning method and transferred to the LMF, the LMF may indicate a positioning procedure to the UE, for only the positioning method including the multi-QoS support indicator.

According to an embodiment of the disclosure, when indicating accuracy information of multiple QoS levels, the LMF may add at least one of the following pieces of information to an LPP RequestLocationInformation message. However, the disclosure is not limited to the example below.

Multiple (e.g., 2 or 3) accuracy values may be included in a CommonIEsRequestLocationInformation part. When two accuracy values are included, the accuracy values may respectively indicate a preferred QoS level accuracy and a minimum level accuracy. When three accuracy values are included, the accuracy values may refer to a preferred QoS level accuracy, an intermediate level accuracy, and a minimum QoS level accuracy, respectively. Each accuracy value may include at least one of a horizontal accuracy or a vertical accuracy. Alternatively, the accuracy information of multiple QoS levels may be included identically in a RequestlocationInformation part of each positioning method.

Examples of transferring accuracy values will be described below. However, the disclosure is not limited to the example below.

Opt 1. The H-accuracy value and the V-accuracy value may have separate list formats and may have the following structure.

QoS ::= SEQUENCE {

| | |
|---|---|
| horizontalAccurancy | HorizontalAccuracy |

| | |
|---|---|
| OPTIONAL, | -- Need ON |

| verticalCoordinateRequest | BOOLEAN, | |
|---|---|---|
| verticalAccuracy | VerticalAccuracy | OPTIONAL, |

-- Need ON

| | |
|---|---|
| responseTime | ResponseTime |

| | |
|---|---|
| OPTIONAL, | -- Need ON |

| | |
|---|---|
| velocityRequest | BOOLEAN, |

...,

| | | |
|---|---|---|
| [[ | responseTimeNB-r14 | ResponseTimeNB-r14 |

| | |
|---|---|
| OPTIONAL | -- Need ON |

]],

| | | |
|---|---|---|
| [[ | horizontalAccuracyExt-r15 | HorizontalAccuracyExt-r15 |

| | |
|---|---|
| OPTIONAL, | -- Need ON |

| | |
|---|---|
| verticalAccuracyExt-r15 | VerticalAccuracyExt-r15 |

| | |
|---|---|
| OPTIONAL | -- Need ON |

]],

| | | |
|---|---|---|
| [[ | horizontalAccuracyExtSet-r18 | HorizontalAccuracyExtSet-r18 |

| | |
|---|---|
| OPTIONAL, | -- Need ON |

verticalAccuracyExtSet-r18

| | | |
|---|---|---|
| VerticalAccuracyExtSet-r18 | OPTIONAL, | -- Need ON |

]]
}
HorizontalAccuracy ::= SEQUENCE {

| | |
|---|---|
| accuracy | INTEGER(0..127), |
| confidence | INTEGER(0..100), |

...
}
VerticalAccuracy ::= SEQUENCE {

| | |
|---|---|
| accuracy | INTEGER(0..127), |
| confidence | INTEGER(0..100), |

...
}
HorizontalAccuracyExt-r15 ::= SEQUENCE {

| | |
|---|---|
| accuracyExt-r15 | INTEGER(0..255), |
| confidence-r15 | INTEGER(0..100), |

...
}
VerticalAccuracyExt-r15 ::= SEQUENCE {

| | |
|---|---|
| accuracyExt-r15 | INTEGER(0..255), |
| confidence-r15 | INTEGER(0..100), |

...
}

| | | |
|---|---|---|
| HorizontalAccuracyExtSet-r18 | :: = | SEQUENCE (SIZE (1..3)) OF |

Horizontal AccuracyExt-r15
VerticalAccuracyExtSet-r18 ::= SEQUENCE (SIZE (1..3)) OF VerticalAccuracyExt-
r15

In this case, the order of elements in the above-described list may indicate an order from the highest accuracy to the smallest or an order from the highest accuracy of the stringency level to the smallest. Elements in the same order in each list may be paired. That is, the first element of H- and the first element of V- may represent H/V accuracy information of the highest accuracy. A HorizontalAccuracy or VerticalAccuracy value of a specific element of a specific list itself may have a meaning of null. Alternatively, in the case where only one element is given in one list, the same accuracy value may be applied to all elements of the remaining list.

In this case, an accuracy level indicated in ProvideLocationInformation of the UE may include the highest accuracy value among satisfied accuracies on the H-accuracy list or an index of the order of the highest accuracy value.

Opt 2. The LMF may include and transfer, to the UE, a unique accuracy value for each of the multiple QoSs.

In this case, the LMF may transfer a field including H-/V-accuracy values for each QoS to the UE, and the field may have a structure as follows. IEs may be described according to Table 4 and Table 5 below. However, the disclosure is not limited to the example below.

### CommonIEsRequestLocationInformation

CommonIEsRequestLocationInformation may transfer common IEs for a request location information LPP message type (The CommonIEsRequestLocationInformation carries common IEs for a Request Location Information LPP message Type).

-- ASN1START
CommonIEsRequestLocationInformation ::= SEQUENCE {

| | |
|---|---|
| locationInformationType | LocationInformationType, |

| | |
|---|---|
| triggeredReporting | TriggeredReportingCriteria |

| | |
|---|---|
| OPTIONAL, | -- Cond ECID |

| | |
|---|---|
| periodicalReporting | PeriodicalReportingCriteria |

| | |
|---|---|
| OPTIONAL, | -- Need ON |

| | |
|---|---|
| additionalInformation | AdditionalInformation |

| | |
|---|---|
| OPTIONAL, | -- Need ON |

| qos | | QoS |
|---|---|---|
| | OPTIONAL, | -- Need ON |

| | |
|---|---|
| environment | Environment |

| | |
|---|---|
| OPTIONAL, | -- Need ON |

| | |
|---|---|
| locationCoordinateTypes | LocationCoordinateTypes |

| | |
|---|---|
| OPTIONAL, | -- Need ON |

| | |
|---|---|
| velocityTypes | VelocityTypes |

| | |
|---|---|
| OPTIONAL, | -- Need ON |

```
  ...,
  [[
```

| | |
|---|---|
| messageSizeLimitNB-r14 | MessageSizeLimitNB-r14 |

| | |
|---|---|
| OPTIONAL | -- Need ON |

```
  ]],
  [[
```

| | |
|---|---|
| segmentationInfo-r14 | SegmentationInfo-r14 |

| | |
|---|---|
| OPTIONAL | -- Need ON |

```
  ]],
  [[
```

scheduledLocationTime-r17

| | | |
|---|---|---|
| ScheduledLocationTime-r17 | OPTIONAL, | -- Need ON |

targetIntegrityRisk-r17

| | | |
|---|---|---|
| TargetIntegrityRisk-r17 | OPTIONAL | -- Need ON |

```
  ]]
}
LocationInformationType ::= ENUMERATED {
  locationEstimateRequired,
  locationMeasurementsRequired,
  locationEstimatePreferred,
  locationMeasurementsPreferred,
  ...
}
```

| | |
|---|---|
| PeriodicalReportingCriteria ::= | SEQUENCE { |

```
  reportingAmount
  ENUMERATED {
```

ra1, ra2, ra4, ra8, ra16, ra32,
ra64, ra-Infinity

} DEFAULT ra-Infinity,

| | |
|---|---|
| reportingInterval | ENUMERATED { |

noPeriodicalReporting, ri0-25,
ri0-5, ril, ri2, ri4, ri8, ri16, ri32, ri64

}
}

| | |
|---|---|
| TriggeredReportingCriteria ::= | SEQUENCE { |

```
  cellChange
  BOOLEAN,
  reportingDuration
  ReportingDuration,
  ...
}
```

| | |
|---|---|
| ReportingDuration ::= | INTEGER (0..255) |

```
AdditionalInformation ::= ENUMERATED {
  onlyReturnInformationRequested,
  mayReturnAditionalInformation,
  ...
}
QoS ::= SEQUENCE {
```

| | |
|---|---|
| horizontalAccuracy | HorizontalAccuracy |

| | |
|---|---|
| OPTIONAL, | -- Need ON |

| verticalCoordinateRequest | BOOLEAN, | |
|---|---|---|
| verticalAccuracy | VerticalAccuracy | OPTIONAL, |

-- Need ON

| | |
|---|---|
| responseTime | ResponseTime |

| | |
|---|---|
| OPTIONAL, | -- Need ON |

| | |
|---|---|
| velocityRequest | BOOLEAN, |

...,

| | | |
|---|---|---|
| [[ | responseTimeNB-r14 | ResponseTimeNB-r14 |

| | |
|---|---|
| OPTIONAL | -- Need ON |

]],

| | | |
|---|---|---|
| [[ | horizontalAccuracyExt-r15 | HorizontalAccuracyExt-r15 |

| | |
|---|---|
| OPTIONAL, | -- Need ON |

| | |
|---|---|
| verticalAccuracyExt-r15 | VerticalAccuracyExt-r15 |

| | |
|---|---|
| OPTIONAL | -- Need ON |

]],

| | | |
|---|---|---|
| [[ | multiQoS-r18 | MultiQoS-r18 |

| | |
|---|---|
| OPTIONAL, | -- Cond UEB |

]]
}
HorizontalAccuracy ::= SEQUENCE {

| | |
|---|---|
| accuracy | INTEGER(0..127), |
| confidence | INTEGER(0..100), |

...
}
VerticalAccuracy ::= SEQUENCE {

| | |
|---|---|
| accuracy | INTEGER(0..127), |
| confidence | INTEGER(0..100), |

...
}
HorizontalAccuracyExt-r15 ::= SEQUENCE {

| | |
|---|---|
| accuracyExt-r15 | INTEGER(0..255), |
| confidence-r15 | INTEGER(0..100), |

...
}
VerticalAccuracyExt-r15 ::= SEQUENCE {

| | |
|---|---|
| accuracyExt-r15 | INTEGER(0..255), |
| confidence-r15 | INTEGER(0..100), |

...
}
MultiQoS-r18 ::= SEQUENCE (SIZE (1..3)) OF QoS_param
QoS_param ::= SEQUENCE {

| | |
|---|---|
| accuracyLevel | INTEGER(0..2) |

| | |
|---|---|
| horizontalAccuracyExt-r15 | HorizontalAccuracyExt-r15 |

| | |
|---|---|
| OPTIONAL, | -- Need ON |

| | |
|---|---|
| verticalCoordinateRequest | BOOLEAN, |
| vertical AccuracyExt-r15 | VerticalAccuracyExt-r15 |

| | |
|---|---|
| OPTIONAL, | -- Need ON |

```
}
Response Time ::= SEQUENCE {
  time
  INTEGER (1..128),
  ...,
```

| | | |
|---|---|---|
| [[ | responseTimeEarlyFix-r12 | INTEGER (1..128) |

| | |
|---|---|
| OPTIONAL | -- Need ON |

]],

| | | |
|---|---|---|
| [[ | unit-r15 | ENUMERATED { ten- |

seconds, ... , ten-milli-seconds-v1700 }

OPTIONAL

```
  -- Need ON
  ]]
}
ResponseTimeNB-r14 ::= SEQUENCE {
  timeNB-r14
  INTEGER (1..512),
```

| | |
|---|---|
| responseTimeEarlyFixNB-r14 | INTEGER (1..512) |

| | |
|---|---|
| OPTIONAL, | -- Need ON |

...,

| | | |
|---|---|---|
| [[ | unitNB-r15 | ENUMERATED |

| | | |
|---|---|---|
| { ten-seconds, ... } | OPTIONAL | -- Need ON |

```
  ]]
}
Environment ::= ENUMERATED {
  badArea,
  notBadArea,
  mixedArea,
  ...
}
MessageSizeLimitNB-r14 ::= SEQUENCE {
```

| | |
|---|---|
| measurementLimit-r14 | INTEGER (1..512) |

| | |
|---|---|
| OPTIONAL, | -- Need ON |

...
}
ScheduledLocationTime-r17 ::= SEQUENCE {

| | |
|---|---|
| utcTime-r17 | UTCTime |

OPTIONAL,

-- Need ON

| | |
|---|---|
| gnssTime-r17 | SEQUENCE { |

gnss-TOD-msec-r17

INTEGER (0..3599999),

gnss-TimeID-r17

GNSS-ID

}

| | |
|---|---|
| OPTIONAL, | -- Need ON |

| | |
|---|---|
| networkTime-r17 | CHOICE { |

e-utraTime-r17

SEQUENCE {

lte-

| | |
|---|---|
| PhysCellId-r17 | INTEGER (0..503), |

lte-

| | |
|---|---|
| ArfcnEUTRA-r17 | ARFCN-ValueEUTRA, |

lte-

| | |
|---|---|
| CellGlobalId-r17 | CellGlobalIdEUTRA-AndUTRA |
| OPTIONAL, | -- Need ON |

lte-

SystemFrameNumber-r17 INTEGER (0..1023)

},
nrTime-r17

SEQUENCE {

nr-

| | |
|---|---|
| PhysCellID-r17 | NR-PhysCellID-r16, |

nr-ARFCN-

| | |
|---|---|
| r17 | ARFCN-ValueNR-r15, |

| | | | nr- |
|---|---|---|---|
| CellGlobalID-r17 | NCGI-r15 | OPTIONAL, | -- |

Need ON

nr-SFN-r17

INTEGER (0..1023),

nr-Slot-r17

CHOICE {

| | |
|---|---|
| scs15-r17 | INTEGER (0..9), |
| scs30-r17 | INTEGER (0..19), |
| scs60-r17 | INTEGER (0..39), |
| scs120-r17 | INTEGER (0..79) |

}

| | |
|---|---|
| OPTIONAL | -- Need ON |

},
...

}

| | |
|---|---|
| OPTIONAL, | -- Need ON |

relativeTime-r17 INTEGER (1..1024)

| | |
|---|---|
| OPTIONAL | -- Need ON |

}

| | |
|---|---|
| TargetIntegrityRisk-r17 ::= | INTEGER (10..90) |

-- ASN1STOP

TABLE 4

| Conditional | |
|---|---|
| presence | Explanation |
| ECID | The field is optionally present, need ON, if E-CID or NR |
| | E-CID is requested. Otherwise, it is not present. |
| UEB | If locationInformationType is configured as |
| | locationEstimateRequired, locationEstimatePreferred, or |
| | locationMeasurementsPreferred, this field may be |
| | optionally present, and otherwise, may not exist (The field |
| | is optionally present, need ON, if the |
| | locationInformationType is set to |
| | locationEstimateRequired, locationEstimatePreferred, or |
| | locationMeasurementsPreferred; otherwise it is not |
| | present.). |

TABLE 5
CommonIEsRequestLocationInformation field descriptions

locationInformationType
This IE indicates whether the server requires a location estimate or measurements.
For ‘locationEstimateRequired’, the target device shall return a location estimate if
possible, or indicate a location error if not possible. For
‘locationMeasurementsRequired’, the target device shall return measurements if
possible, or indicate a location error if not possible. For
‘locationEstimatePreferred, the target device shall return a location estimate if
possible, but may also or instead return measurements for any requested position
methods for which a location estimate is not possible. For
‘locationMeasurementsPreferred’, the target device shall return location
measurements if possible, but may also or instead return a location estimate for
any requested position methods for which return of location measurements is not
possible.
triggeredReporting
This IE indicates that triggered reporting is requested and comprises the following
subfields:
cellChange: If this field is set to TRUE, the target device provides
requested location information each time the primary cell has changed.
reportingDuration: Maximum duration of triggered reporting in seconds.
A value of zero is interpreted to mean an unlimited (i.e., “infinite”) duration. The
target device should continue triggered reporting for the reportingDuration or until
an LPP Abort or LPP Error message is received.
The triggeredReporting field should not be included by the location server and
shall be ignored by the target device if the periodicalReporting IE or responseTime
IE or responseTimeNB IE is included in CommonIEsRequestLocationInformation.
periodicalReporting
This IE indicates that periodic reporting is requested and comprises the following
subfields:
reportingAmount indicates the number of periodic location information
reports requested. Enumerated values correspond to 1, 2, 4, 8, 16, 32, 64, or
infinite/indefinite number of reports. If the reportingAmount is
‘infinite/indefinite’, the target device should continue periodic reporting until an
LPP Abort message is received. The value ‘ra1’ shall not be used by a sender.
reportingInterval indicates the interval between location information
reports and the response time requirement for the first location information report.
Enumerated values ri0-25, ri0-5, ri1, ri2, ri4, ri8, ri16, ri32, ri64 correspond to
reporting intervals of 1, 2, 4, 8, 10, 16, 20, 32, and 64 seconds, respectively.
Measurement reports containing no measurements or no location estimate are
required when a reportingInterval expires before a target device is able to obtain
new measurements or obtain a new location estimate. The value
‘noPeriodicalReporting’ shall not be used by a sender.
additionalInformation
This IE indicates whether a target device is allowed to return additional
information to that requested. If this IE indicates
‘onlyReturnInformationRequested’ then the target device shall not return any
additional information to that requested by the server. If this IE indicates
‘mayReturnAdditionalInformation’ then the target device may return additional
information to that requested by the server. If a location estimate is returned, any
additional information is restricted to that associated with a location estimate (e.g.,
might include velocity if velocity was not requested but cannot include
measurements). If measurements are returned, any additional information is
restricted to additional measurements (e.g., might include E-CID measurements if
A-GNSS measurements were requested but not E-CID measurements).
qos
This IE indicates the quality of service and comprises a number of sub-fields. In
the case of measurements, some of the sub-fields apply to the location estimate that
could be obtained by the server from the measurements provided by the target
device assuming that the measurements are the only sources of error. Fields are
as follows:

CommonIEsRequestLocationInformation field descriptions

horizontalAccuracy indicates the maximum horizontal error in the
location estimate at an indicated confidence level. The ‘accuracy’ corresponds to
the encoded uncertainty as defined in TS 23.032 [15] and ‘confidence’ corresponds
to confidence as defined in TS 23.032 [15].
verticalCoordinateRequest indicates whether a vertical coordinate is
required (TRUE) or not (FALSE)
verticalAccuracy indicates the maximum vertical error in the location
estimate at an indicated confidence level and is only applicable when a vertical
coordinate is requested. The ‘accuracy’ corresponds to the encoded uncertainty
altitude as defined in TS 23.032 [15] and ‘confidence’ corresponds to confidence
as defined in TS 23.032 [15].
responseTime
time indicates the maximum response time as measured between
receipt of the RequestLocationInformation and transmission of a
ProvideLocationInformation. If the unit field is absent, this is given as an integer
number of seconds between 1 and 128. If the unit field is present with
enumerated value ‘ten-seconds’, the maximum response time is given in units of
10-seconds, between 10 and 1280 seconds. If the unit field is present with
enumerated value ‘ten-milli-seconds’, the maximum response time is given in units
of 10-milli-seconds, between 0.01 and 1.28 seconds. If the periodicalReporting
IE is included in CommonIEsRequestLocationInformation, this field should not be
included by the location server and shall be ignored by the target device (if
included).
responseTimeEarlyFix indicates the maximum response time as
measured between receipt of the RequestLocationInformation and transmission of
a ProvideLocationInformation containing early location measurements or an early
location estimate. If the unit field is absent, this is given as an integer number of
seconds between 1 and 128. If the unit field is present with enumerated value
‘ten-seconds’, the maximum response time is given in units of 10-seconds, between
10 and 1280 seconds. If the unit field is present with enumerated value ‘ten-milli-
seconds’, the maximum response time is given in units of 10-milli-seconds,
between 0.01 and 1.28 seconds. When this IE is included, a target should send a
ProvideLocationInformation (or more than one ProvideLocationInformation if
location information will not fit into a single message) containing early location
information according to the responseTimeEarlyFix IE and a subsequent
ProvideLocationInformation (or more than one ProvideLocationInformation if
location information will not fit into a single message) containing final location
information according to the time IE. A target shall omit sending a
ProvideLocationInformation if the early location information is not available at the
expiration of the time value in the responseTimeEarlyFix IE. A server should set
the responseTimeEarlyFix IE to a value less than that for the time IE. A target
shall ignore the responseTimeEarlyFix IE if its value is not less than that for the
time IE.
unit indicates the unit of the time and responseTimeEarlyFix
fields. Enumerated value ‘ten-seconds’ corresponds to a resolution of 10 seconds.
Enumerated value ‘ten-milli-seconds’ corresponds to a resolution of 0.01 seconds.
If this field is absent, the unit/resolution is 1 second. Enumerated value ‘ten-milli-
seconds’ is only applicable for NR E-CID Positioning, NR DL-TDOA Positioning,
NR DL-AoD Positioning, and NR Multi-RTT Positioning. If the enumerated
value ‘ten-milli-seconds’ is included for methods others than NR E-CID
Positioning, NR DL-TDOA Positioning, NR DL-AoD Positioning, and NR Multi-
RTT Positioning the target device shall ignore the unit field.
velocityRequest indicates whether velocity (or measurements related to
velocity) is requested (TRUE) or not (FALSE).
responseTimeNB
If the periodicalReporting IE or responseTime IE is included in
CommonIEsRequestLocationInformation, this field should not be included by the
location server and shall be ignored by the target device (if included).
timeNB indicates the maximum response time as measured
between receipt of the RequestLocationInformation and transmission of a
ProvideLocationInformation. If the unitNB field is absent, this is given as an
integer number of seconds between 1 and 512. If the unitNB field is present, the
maximum response time is given in units of 10-seconds, between 10 and 5120
seconds.
responseTimeEarlyFixNB indicates the maximum response
time as measured between receipt of the RequestLocationInformation and
transmission of a ProvideLocationInformation containing early location
measurements or an early location estimate. If the unitNB field is absent, this is
given as an integer number of seconds between 1 and 512. If the unitNB field is
present, the maximum response time is given in units of 10-seconds, between 10
and 5120 seconds. When this IE is included, a target should send a
ProvideLocationInformation (or more than one ProvideLocationInformation if
location information will not fit into a single message) containing early location
information according to the responseTimeEarlyFixNB IE and a subsequent
ProvideLocationInformation (or more than one ProvideLocationInformation if
location information will not fit into a single message) containing final location
information according to the timeNB IE. A target shall omit sending a
ProvideLocationInformation if the early location information is not available at the
expiration of the time value in the responseTimeEarlyFixNB IE. A server should
set the responseTimeEarlyFixNB IE to a value less than that for the timeNB IE. A
target shall ignore the responseTimeEarlyFixNB IE if its value is not less than that
for the timeNB IE.
unitNB indicates the unit of the timeNB and
responseTimeEarlyFixNB fields. Enumerated value ‘ten-second’ corresponds to
a resolution of 10 seconds. If this field is absent, the unit/resolution is 1 second.
horizontalAccuracyExt indicates the maximum horizontal error in the
location estimate at an indicated confidence level. The ‘accuracyExt’ corresponds
to the encoded high accuracy uncertainty as defined in TS

CommonIEsRequestLocationInformation field descriptions

23.032 [15] and ‘confidence’ corresponds to confidence as defined in TS 23.032
[15]. This field should not be included by the location server and shall be ignored
by the target device if the horizontalAccuracy field is included in QoS.
verticalAccuracyExt indicates the maximum vertical error in the location
estimate at an indicated confidence level and is only applicable when a vertical
coordinate is requested. The ‘accuracyExt’ corresponds to the encoded high
accuracy uncertainty as defined in TS 23.032 [15] and ‘confidence’ corresponds to
confidence as defined in TS 23.032 [15]. This field should not be included by the
location server and shall be ignored by the target device if the verticalAccuracy
field is included in QoS.
multiQoS may indicate a QoS parameter set for each QoS level when the target
UE is allowed to satisfy the multiple QoS levels for an obtained location estimate
without receiving an additional LPP signal from the LMF. If this field is
indicated, the target UE may report location estimate and an accuracy level of the
highest satisfied QoS level among the indicated multiple QoS levels. If there is
a multi-QoS level field, no horizontalAccuray, verticalAccuray, and
verticalCoordinateRequest are required (multiQoS indicates set of the QoS
parameters per each QoS level when the target UE is allowed to fulfil multiple QoS
levels for the obtained location estimate without further LPP signaling from LMF.
When this field is indicated, the target UE can report the location estimate with the
accuracyLevel of the highest QoS level fulfilled among the indicated multiple QoS
levels. If this field is present, there should be no horizontalAccuray,
verticalAccuray nor verticalCoordinateRequest.)
QoS_param may indicate a parameter for each QoS level. In the QoS_param
field, the following sub parameters horizontalAccuracyExt, verticalAccuracyExt,
verticalCoordinateRequest, and accuracyLevel may be present. accuracyLevel
may indicate the identification of each QoS level to be satisfied, and the order of
the stringency level. That is, “0” may mean the most preferred or stringent QoS
level, and “1” may means the next or intermediate preferred/stringent QoS level.
This field may have the following sub parameters, horizontalAccuracyExt,
verticalAccuracyExt, verticalCoordinateRequest, and accuracyLevel.
accuracyLevel indicates the identification of each QoS level to be fulfilled, and the
order of the stringency level, i.e., ‘0’ means the most preferred or stringent QoS
level, and ‘1’ means the next or intermediate preferred/stringent QoS level, and so on.)
All QoS requirements shall be obtained by the target device to the degree possible
but it is permitted to return a response that does not fulfill all QoS requirements if
some were not attainable. The single exception is time and timeNB which shall
always be fulfilled - even if that means not fulfilling other QoS requirements.
A target device supporting NB-IoT access shall support the responseTimeNB IE.
A target device supporting HA GNSS shall support the HorizontalAccuracyExt,
VerticalAccuracyEx, and unit fields with enumerated value ‘ten-seconds’.
A target device supporting NB-IoT access and HA GNSS shall support the unitNB
field.

In this case, the QoS_param field may include an accuracy value configurable per QoS, and the multiQoS field has a structure of a list of QoS-param and may include QoS-param for each of QoSs indicated by the LCS client to the LMF.

The QoS_param field may include at least one of horizontalaccuracy, verticalAccuracy, or a verticalcoordinateRequest indicator associated for each QoS. In addition, the QoS param field may include an indicator called accuracyLevel. accuracyLevel may be an indicator for indicating each QoS_param field, may have one value among 0, 1, or 2, and may indicate up to three QoSs in a highest accuracy order. For example, 0 may be the highest level of accuracy, 1 may be the intermediate level, and 2 may be the lowest level. When the UE performs measurement, if there is a QoS satisfying an accuracy, the UE may transmit a report including a value indicating the highest QoS among QoSs corresponding to accuracyLevel. The report may be included in a ProvideLocationInformation message, and include the following description.

If the multiQoS field is used, the existing fields, such as horizontalAccuracy, verticalAccuracy, and verticalcoordinateRequest fields, may not be used. IEs may be described according to Table 6 and Table 7 below. However, the disclosure is not limited to the example below.

### CommonIEsProvideLocationInformation

CommonIEsProvideLocationInformation may transfer common IEs for a location information provision LPP message type (The CommonIEsProvideLocationInformation carries common IEs for a Provide Location Information LPP message Type).

-- ASN1START
CommonIEsProvideLocationInformation ::= SEQUENCE {

| | |
|---|---|
| locationEstimate | LocationCoordinates |

OPTIONAL,

| | |
|---|---|
| velocityEstimate | Velocity |

OPTIONAL,

| | |
|---|---|
| locationError | LocationError |

```
  OPTIONAL,
  ...,
```

| | | |
|---|---|---|
| [[ | earlyFixReport-r12 | EarlyFixReport-r12 |

```
  OPTIONAL
  ]],
```

| | | |
|---|---|---|
| [[ | locationSource-r13 | LocationSource-r13 |

OPTIONAL,

| | |
|---|---|
| locationTimestamp-r13 | UTCTime |

OPTIONAL

```
  ]],
  [[
```

| | | |
|---|---|---|
| segmentationInfo-r14 | SegmentationInfo-r14 | OPTIONAL |

-- Cond Segmentation

```
  ]],
  [[
```

| | | |
|---|---|---|
| integrityInfo-r17 | IntegrityInfo-r17 | OPTIONAL |

]],

| | | | |
|---|---|---|---|
| [[ | achievedQoSLevel-r18 | AchievedQoSLevel-r18 | OPTIONAL |

-- Cond MultipleQoS

```
  ]]
}
LocationCoordinates ::= CHOICE {
  ellipsoidPoint
  Ellipsoid-Point,
```

| | |
|---|---|
| ellipsoidPointWithUncertaintyCircle | Ellipsoid- |

```
PointWithUncertaintyCircle,
  ellipsoidPointWithUncertaintyEllipse
  EllipsoidPointWithUncertaintyEllipse,
  polygon
```

Polygon,

```
  ellipsoidPointWithAltitude
  EllipsoidPointWithAltitude,
  ellipsoidPointWithAltitudeAndUncertaintyEllipsoid
```

EllipsoidPointWithAltitudeAndUncertaintyEllipsoid,

```
  ellipsoidArc
  EllipsoidArc,
  ...,
  highAccuracyEllipsoidPointWithUncertaintyEllipse-v1510
  HighAccuracyEllipsoidPointWithUncertaintyEllipse-r15,
  highAccuracyEllipsoidPointWithAltitudeAndUncertaintyEllipsoid-v1510
  HighAccuracyEllipsoidPointWithAltitudeAndUncertaintyEllipsoid-r15,
  ha-EllipsoidPointWithScalableUncertaintyEllipse-v1680
```

HA-

EllipsoidPointWithScalableUncertaintyEllipse-r16,
ha-EllipsoidPointWithAltitudeAndScalableUncertaintyEllipsoid-v1680

HA-

```
EllipsoidPointWithAltitudeAndScalableUncertaintyEllipsoid-r16
}
Velocity ::= CHOICE {
  horizontalVelocity
  HorizontalVelocity,
  horizontalWithVerticalVelocity
  HorizontalWithVerticalVelocity,
  horizontalVelocityWithUncertainty
  HorizontalVelocityWithUncertainty,
  horizontalWithVerticalVelocityAndUncertainty
HorizontalWithVerticalVelocityAndUncertainty,
  ...
}
LocationError ::= SEQUENCE {
```

| | |
|---|---|
| locationfailurecause | LocationFailureCause, |

```
  ...
}
LocationFailureCause ::= ENUMERATED {
  undefined,
  requestedMethodNotSupported,
  positionMethodFailure,
  periodicLocationMeasurementsNotAvailable,
  ...
}
EarlyFixReport-r12 ::= ENUMERATED {
  noMoreMessages,
  moreMessagesOnTheWay
}
```

| | | |
|---|---|---|
| LocationSource-r13 ::= BIT STRING { | a-gnss | (0), |

wlan

(1),

bt

(2),

tbs

| | |
|---|---|
| | (3), |
| sensor | (4), |

ha-

| | |
|---|---|
| gnss-v1510 | (5), |

motion-sensor-v1550 (6),

dl-

| | |
|---|---|
| tdoa-r16 | (7), |

dl-

| | |
|---|---|
| aod-r16 | (8) } (SIZE(1..16)) |

IntegrityInfo-r17 ::= SEQUENCE {

| | |
|---|---|
| horizontalProtectionLevel-r17 | INTEGER (0..50000), |
| verticalProtectionLevel-r17 | INTEGER (0..50000) |

OPTIONAL,

achievableTargetIntegrityRisk-r17 INTEGER (10..90)

OPTIONAL,

...
}
AchievedQoSLevel-r18 ::= INTEGER(0..2)
-- ASN1STOP

TABLE 6

| Conditional | |
|---|---|
| presence | Explanation |
| Segmentation | This field is optionally present, need OP, if lpp-message- |
| | segmentation-req has been received from the location server |
| | with bit 1 (targetToServer) set to value 1. The field shall be |
| | omitted if lpp-message-segmentation-req has not been |
| | received in this location session, or has been received with bit |
| | 1 (targetToServer) set to value 0. |
| MultipleQoS | A MultipleQoS field is optionally present, and when |
| | multiQoS-r18 is received from a location server, the field |
| | exits. If multiQoS-r18 is not received in this location |
| | session, the MultipleQoS field is omitted. (This field is |
| | optionally present, need OP, if multiQoS-r18 has been |
| | received from the location server. The field shall be omitted |
| | if multiQoS-r18 has not been received in this location |
| | session.) |

TABLE 7
CommonIEsProvideLocationInformation field descriptions

locationEstimate
This field provides a location estimate using one of the geographic shapes defined
in TS 23.032 [15]. Coding of the values of the various fields internal to each
geographic shape follow the rules in TS 23.032 [15]. The conditions for
including this field are defined for the locationInformationType field in a Request
Location Information message.
achievedQoSLevel
achievedQoSLevel may indicate accuracyLevel of the highest QoS level satisfied
by this locationEstimate result among multiple QoSs indicated in the
ProvideLocationInformation message (This indicates the accuracyLevel of the
highest QoS level fulfilled by this locationEstimate result among the indicated
multiple QoS levels in ProvideLocationInformation message.)
velocityEstimate
This field provides a velocity estimate using one of the velocity shapes defined in
TS 23.032 [15]. Coding of the values of the various fields internal to each
velocity shape follow the rules in TS 23.032 [15].
locationError
This field shall be included if and only if a location estimate and measurements
are not included in the LPP PDU. The field includes information concerning the
reason for the lack of location information. The LocationFailureCause
‘periodicLocationMeasurementsNotAvailable’ shall be used by the target device
if periodic location reporting was requested, but no measurements or location
estimate are available when the reportingInterval expired.
earlyFixReport
This field shall be included if and only if the ProvideLocationInformation
message contains early location measurements or an early location estimate.
The target device shall set the values of this field as follows:
noMoreMessages: This is the only or last ProvideLocationInformation
message used to deliver the entire set of early location information.
moreMessagesOnTheWay: This is one of multiple
ProvideLocationInformation messages used to deliver the entire set of early
location information (if early location information will not fit into a single
message).
If this field is included, the IE SegmentationInfo shall not be included.
locationSource
This field provides the source positioning technology for the location estimate.
NOTE 1: In this version of the specification, the entry ‘tbs' is used only
for TBS positioning based on MBS signals.
NOTE 2: The entry ‘sensor’ is used only for positioning technology that
uses barometric pressure sensor. The entry ‘motion-sensor’ is used for
positioning technology that uses sensor(s) to detect displacement and movement,
e.g., accelerometers, gyros, magnetometers.
locationTimestamp
This field provides the UTC time when the location estimate is valid and should
take the form of YYMMDDhhmmssZ.
segmentationInfo
This field indicates whether this ProvideLocationInformation message is one of
many segments, as specified in clause 4.3.5
integrityInfo
This field provides the integrity result for the locationEstimate.
horizontalProtectionLevel provides the HPL for the locationEstimate
along the semi-major axis of the error ellipse. Scale factor 0.01 metre;
range 0-500 metres.
verticalProtectionLevel provides the VPL for the locationEstimate.
Scale factor 0.01 metre; range 0-500 metres.
achievableTargetIntegrityRisk indicates the achievable TIR for which
the HPL and VPL are provided. The achievable TIR is given by P = 10^{-0.1n}
[hour⁻¹] where n is the value of achievableTargetIntegrityRisk and the range is 10⁻¹ to
10⁻⁹ per hour. If this field is absent, the achievable TIR is the same as the
targetIntegrityRisk in CommonIEsRequestLocationInformation.

In an embodiment of the disclosure, Opt 3 may be a method in which existing horizontalAccuracy and verticalAccuracy may represent the highest QoS level, and if the LMF desires, one or two pairs of H-/V-accuracy values are additionally transferred. In this case, the existing horizontalAccuracy and verticalAccuracy fields need to be used, and a minorLocQoS field may be indicated additionally. The minorLocQoS field may have a list of up to two H/V-accuracy pairs. The order of the elements of the list may follow a high accuracy level.

In this case, when the UE performs measurement and indicates and reports the highest QoS level satisfying an accuracy, the highest satisfied accuracy value pair may be directly reported. Alternatively, in the case of no indicator, this may indicate the highest level among the indicated QoS levels, and in the case of reporting a number 1 or 2, this may indicate the first or second QoS level of the minorLocQoS field. IEs may be described according to Table 8 and Table 9 below. However, the disclosure is not limited to the example below.

### CommonIEsRequestLocationInformation

CommonIEsRequestLocationInformation may transfer common IEs for a request location information LPP message type (The CommonIEsRequestLocationInformation carries common IEs for a Request Location Information LPP message Type).

-- ASN1START
CommonIEsRequestLocationInformation ::= SEQUENCE {

| | |
|---|---|
| locationInformationType | LocationInformationType, |

| | |
|---|---|
| triggeredReporting | TriggeredReportingCriteria |

| | |
|---|---|
| OPTIONAL, | -- Cond ECID |

| | |
|---|---|
| periodicalReporting | PeriodicalReportingCriteria |

| | |
|---|---|
| OPTIONAL, | -- Need ON |

| | |
|---|---|
| additionalInformation | AdditionalInformation |

| | |
|---|---|
| OPTIONAL, | -- Need ON |

qos

| | QoS |
|---|---|
| OPTIONAL, | -- Need ON |

| | |
|---|---|
| environment | Environment |

| | |
|---|---|
| OPTIONAL, | -- Need ON |

| | |
|---|---|
| locationCoordinateTypes | LocationCoordinateTypes |

| | |
|---|---|
| OPTIONAL, | -- Need ON |

| | |
|---|---|
| velocityTypes | VelocityTypes |

| | |
|---|---|
| OPTIONAL, | -- Need ON |

```
  ...,
  [[
```

| | |
|---|---|
| messageSizeLimitNB-r14 | MessageSizeLimitNB-r14 |

| | |
|---|---|
| OPTIONAL | -- Need ON |

```
  ]],
  [[
```

| | |
|---|---|
| segmentationInfo-r14 | SegmentationInfo-r14 |

| | |
|---|---|
| OPTIONAL | -- Need ON |

```
  ]],
  [[
```

scheduledLocationTime-r17

| | | |
|---|---|---|
| ScheduledLocationTime-r17 | OPTIONAL, | -- Need ON |

targetIntegrityRisk-r17

| | | |
|---|---|---|
| TargetIntegrityRisk-r17 | OPTIONAL | -- Need ON |

```
  ]]
}
LocationInformationType :: = ENUMERATED {
  locationEstimateRequired,
  locationMeasurementsRequired,
  locationEstimatePreferred,
  locationMeasurementsPreferred,
  ...
}
```

| | |
|---|---|
| PeriodicalReportingCriteria ::= | SEQUENCE { |

```
  reportingAmount
  ENUMERATED {
```

ra1, ra2, ra4, ra8, ra16, ra32,
ra64, ra-Infinity

} DEFAULT ra-Infinity,

| | |
|---|---|
| reportingInterval | ENUMERATED { |

noPeriodicalReporting, ri0-25,
ri0-5, ri1, ri2, ri4, ri8, ri16, ri32, ri64

}
}

| | |
|---|---|
| TriggeredReportingCriteria ::= | SEQUENCE { |

```
  cellChange
  BOOLEAN,
  reportingDuration
  ReportingDuration,
  ...
}
```

| | |
|---|---|
| ReportingDuration ::= | INTEGER (0..255) |

```
AdditionalInformation ::= ENUMERATED {
  onlyReturnInformationRequested,
  mayReturnAditionalInformation,
  ...
}
QoS ::= SEQUENCE {
```

| | |
|---|---|
| horizontalAccuracy | HorizontalAccuracy |

| | |
|---|---|
| OPTIONAL, | -- Need ON |

| verticalCoordinateRequest | BOOLEAN, | |
|---|---|---|
| verticalAccuracy | VerticalAccuracy | OPTIONAL, |

-- Need ON

| | |
|---|---|
| responseTime | ResponseTime |

| | |
|---|---|
| OPTIONAL, | -- Need ON |

| | |
|---|---|
| velocityRequest | BOOLEAN, |

...,

| | | |
|---|---|---|
| [[ | responseTimeNB-r14 | ResponseTimeNB-r14 |

| | |
|---|---|
| OPTIONAL | -- Need ON |

]],

| | | |
|---|---|---|
| [[ | horizontalAccuracyExt-r15 | HorizontalAccuracyExt-r15 |

| | |
|---|---|
| OPTIONAL, | -- Need ON |

| | |
|---|---|
| verticalAccuracyExt-r15 | VerticalAccuracyExt-r15 |

| | |
|---|---|
| OPTIONAL | -- Need ON |

]],

| | | |
|---|---|---|
| [[ | minorLocQoS-r18 | MinorLocQoS-r18 |

| | |
|---|---|
| OPTIONAL, | -- Cond UEB |

]]
}
HorizontalAccuracy ::= SEQUENCE {

| | |
|---|---|
| accuracy | INTEGER(0..127), |
| onfidence | INTEGER(0..100), |

...
}
VerticalAccuracy ::= SEQUENCE {

| | |
|---|---|
| accuracy | INTEGER(0..127), |
| confidence | INTEGER(0..100), |

...
}
HorizontalAccuracyExt-r15 ::= SEQUENCE {

| | |
|---|---|
| accuracyExt-r15 | INTEGER(0..255), |
| confidence-r15 | INTEGER(0..100), |

...
}
VerticalAccuracyExt-r15 ::= SEQUENCE {

| | |
|---|---|
| accuracyExt-r15 | INTEGER(0..255), |
| confidence-r15 | INTEGER(0..100), |

...
}
MinorLocQoS-r18 ::= SEQUENCE (SIZE (1..2)) OF QoS_param
QoS_param ::= SEQUENCE {

| | |
|---|---|
| accuracyLevel | INTEGER(0..2) |

| | |
|---|---|
| horizontalAccuracyExt-r15 | HorizontalAccuracyExt-r15 |

| | |
|---|---|
| OPTIONAL, | -- Need ON |

| | |
|---|---|
| verticalAccuracyExt-r15 | VerticalAccuracyExt-r15 |

| | |
|---|---|
| OPTIONAL, | -- Need ON |

```
}
ResponseTime ::= SEQUENCE {
  time
  INTEGER (1..128),
  ...,
```

| | | |
|---|---|---|
| [[ | responseTimeEarlyFix-r12 | INTEGER (1..128) |

| | |
|---|---|
| OPTIONAL | -- Need ON |

]],

| | | |
|---|---|---|
| [[ | unit-r15 | ENUMERATED { ten- |

seconds, ... , ten-milli-seconds-v1700 }

OPTIONAL

```
  -- Need ON
  ]]
}
ResponseTimeNB-r14 ::= SEQUENCE {
  timeNB-r14
  INTEGER (1..512),
```

| | |
|---|---|
| responseTimeEarlyFixNB-r14 | INTEGER (1..512) |

| | |
|---|---|
| OPTIONAL, | -- Need ON |

...,

| | | |
|---|---|---|
| [[ | unitNB-r15 | ENUMERATED |

| | | |
|---|---|---|
| { ten-seconds, ... } | OPTIONAL | -- Need ON |

```
  ]]
}
Environment ::= ENUMERATED {
  badArea,
  notBadArea,
  mixedArea,
  ...
}
MessageSizeLimitNB-r14 ::= SEQUENCE {
```

| | |
|---|---|
| measurementLimit-r14 | INTEGER (1..512) |

| | |
|---|---|
| OPTIONAL, | -- Need ON |

...
}
ScheduledLocationTime-r17 ::= SEQUENCE {

| | |
|---|---|
| utcTime-r17 | UTCTime |

OPTIONAL,

-- Need ON

| | |
|---|---|
| gnssTime-r17 | SEQUENCE { |

gnss-TOD-msec-r17

INTEGER (0..3599999),

gnss-TimeID-r17

GNSS-ID

}

| | |
|---|---|
| OPTIONAL, | -- Need ON |

| | |
|---|---|
| networkTime-r17 | CHOICE { |

e-utraTime-r17

SEQUENCE {

lte-

| | |
|---|---|
| PhysCellId-r17 | INTEGER (0..503), |

lte-

| | |
|---|---|
| ArfcnEUTRA-r17 | ARFCN-ValueEUTRA, |

lte-

| | |
|---|---|
| CellGlobalId-r17 | CellGlobalIdEUTRA-AndUTRA |
| OPTIONAL, | -- Need ON |

lte-

| | |
|---|---|
| SystemFrameNumber-r17 | INTEGER (0..1023) |

},
nrTime-r17

SEQUENCE {

nr-

| | |
|---|---|
| PhysCellID-r17 | NR-PhysCellID-r16, |

nr-ARFCN-

| | |
|---|---|
| r17 | ARFCN-ValueNR-r15, |

nr-

| | | | |
|---|---|---|---|
| CellGlobalID-r17 | NCGI-r15 | OPTIONAL, | -- |

Need ON

nr-SFN-r17

INTEGER (0..1023),

nr-Slot-r17

CHOICE {

| | |
|---|---|
| scs15-r17 | INTEGER (0..9), |
| scs30-r17 | INTEGER (0..19), |
| scs60-r17 | INTEGER (0..39), |
| scs120-r17 | INTEGER (0..79) |

}

| | |
|---|---|
| OPTIONAL | -- Need ON |

},
...

}

| | |
|---|---|
| OPTIONAL, | -- Need ON |
| relativeTime-r17 | INTEGER (1..1024) |

| | |
|---|---|
| OPTIONAL | -- Need ON |

}

| | |
|---|---|
| TargetIntegrityRisk-r17 ::= | INTEGER (10..90) |

-- ASN1STOP

TABLE 8

| Conditional | |
|---|---|
| presence | Explanation |
| ECID | The field is optionally present, need ON, if E-CID |
| | or NR E-CID is requested. Otherwise, it is not present. |
| UEB | A UEB field may be optionally present, if |
| | locationInformationType is configured as |
| | locationEstimateRequired, locationEstimatePreferred, or |
| | locationMeasurementsPreferred described above, the |
| | field may exist, and otherwise, may not exist (The |
| | field is optionally present, need ON, if the |
| | locationInformationType is set to |
| | locationEstimateRequired, locationEstimatePreferred, or |
| | locationMeasurementsPreferred; otherwise it is not present). |

TABLE 9
CommonIEsRequestLocationInformation field descriptions

locationInformationType
This IE indicates whether the server requires a location estimate or measurements.
For ‘locationEstimateRequired’, the target device shall return a location estimate
if possible, or indicate a location error if not possible. For
‘locationMeasurementsRequired’, the target device shall return measurements if
possible, or indicate a location error if not possible. For
‘locationEstimatePreferred’, the target device shall return a location estimate if
possible, but may also or instead return measurements for any requested position
methods for which a location estimate is not possible. For
‘locationMeasurementsPreferred’, the target device shall return location
measurements if possible, but may also or instead return a location estimate for
any requested position methods for which return of location measurements is not
possible.
triggeredReporting
This IE indicates that triggered reporting is requested and comprises the following
subfields:
cellChange: If this field is set to TRUE, the target device provides
requested location information each time the primary cell has changed.
reportingDuration: Maximum duration of triggered reporting in seconds.
A value of zero is interpreted to mean an unlimited (i.e., “infinite”) duration. The
target device should continue triggered reporting for the reportingDuration or
until an LPP Abort or LPP Error message is received.
The triggeredReporting field should not be included by the location server and
shall be ignored by the target device if the periodicalReporting IE or responseTime
IE or responseTimeNB IE is included in CommonIEsRequestLocationInformation.
periodicalReporting
This IE indicates that periodic reporting is requested and comprises the following
subfields:
reportingAmount indicates the number of periodic location information
reports requested. Enumerated values correspond to 1, 2, 4, 8, 16, 32, 64, or
infinite/indefinite number of reports. If the reportingAmount is
‘infinite/indefinite’, the target device should continue periodic reporting until an
LPP Abort message is received. The value ‘ra1’ shall not be used by a sender.
reportingInterval indicates the interval between location information
reports and the response time requirement for the first location information report.
Enumerated values ri0-25, ri0-5, ri1, ri2, ri4, ri8, ri16, ri32, ri64 correspond to
reporting intervals of 1, 2, 4, 8, 10, 16, 20, 32, and 64 seconds, respectively.
Measurement reports containing no measurements or no location estimate are
required when a reportingInterval expires before a target device is able to obtain
new measurements or obtain a new location estimate. The value
‘noPeriodicalReporting’ shall not be used by a sender.
additionalInformation
This IE indicates whether a target device is allowed to return additional
information to that requested. If this IE indicates
‘onlyReturnInformationRequested’ then the target device shall not return any
additional information to that requested by the server. If this IE indicates
‘mayReturnAdditionalInformation’ then the target device may return additional
information to that requested by the server. If a location estimate is returned, any
additional information is restricted to that associated with a location estimate (e.g.,
might include velocity if velocity was not requested but cannot include
measurements). If measurements are returned, any additional information is
restricted to additional measurements (e.g., might include E-CID measurements if
A-GNSS measurements were requested but not E-CID measurements).
qos
This IE indicates the quality of service and comprises a number of sub-fields. In
the case of measurements, some of the sub-fields apply to the location estimate
that could be obtained by the server from the measurements provided by the target
device assuming that the measurements are the only sources of error. Fields are
as follows:
horizontalAccuracy indicates the maximum horizontal error in the
location estimate at an indicated confidence level. The ‘accuracy’ corresponds
to the encoded uncertainty as defined in TS 23.032 [15] and ‘confidence’
corresponds to confidence as defined in TS 23.032 [15].
verticalCoordinateRequest indicates whether a vertical coordinate is
required (TRUE) or not (FALSE)
verticalAccuracy indicates the maximum vertical error in the location
estimate at an indicated confidence level and is only applicable when a vertical
coordinate is requested. The ‘accuracy’ corresponds to the encoded uncertainty
altitude as defined in TS 23.032 [15] and ‘confidence’ corresponds to confidence
as defined in TS 23.032 [15].
responseTime
time indicates the maximum response time as measured
between receipt of the RequestLocationInformation and transmission of a
ProvideLocationInformation. If the unit field is absent, this is given as an
integer number of seconds between 1 and 128. If the unit field is present with
enumerated value ‘ten-seconds’, the maximum response time is given in units of
10-seconds, between 10 and 1280 seconds. If the unit field is present with
enumerated value ‘ten-milli-seconds’, the maximum response time is given in
units of 10-milli-seconds, between 0.01 and 1.28 seconds. If the
periodicalReporting IE is included in CommonIEsRequestLocationInformation,
this field should not be included by the location server and shall be ignored by the
target device (if included).
responseTimeEarlyFix indicates the maximum response time
as measured between receipt of the RequestLocationInformation and transmission
of a ProvideLocationInformation containing early location measurements or an
early location estimate. If the unit field is absent, this is given as an integer
number of seconds between 1 and 128. If the unit field is present with
enumerated value ‘ten-seconds’, the maximum response time is given in units of
10-seconds, between 10 and 1280 seconds. If the unit field is present with
enumerated value ‘ten-milli-seconds’, the maximum response time is given in
units of 10-milli-seconds, between 0.01 and 1.28 seconds. When this IE is
included, a target should send a ProvideLocationInformation (or more than one
ProvideLocationInformation if location information will not fit into a single
message) containing early location information according to the
responseTimeEarlyFix IE and a subsequent ProvideLocationInformation (or
more than one ProvideLocationInformation if location information will not fit
into a single message) containing final location information according to the time
IE. A target shall omit sending a ProvideLocationInformation if the early
location information is not available at the expiration of the time value in the
responseTimeEarlyFix IE. A server should set the responseTimeEarlyFix IE to
a value less than that for the time IE. A target shall ignore the
responseTimeEarlyFix IE if its value is not less than that for the time IE.
unit indicates the unit of the time and responseTimeEarlyFix
fields. Enumerated value ‘ten-seconds’ corresponds to a resolution of 10
seconds. Enumerated value ‘ten-milli-seconds’ corresponds to a resolution of
0.01 seconds. If this field is absent, the unit/resolution is 1 second.
Enumerated value ‘ten-milli-seconds’ is only applicable for NR E-CID
Positioning, NR DL-TDOA Positioning, NR DL-AoD Positioning, and NR
Multi-RTT Positioning. If the enumerated value ‘ten-milli-seconds’ is included
for methods others than NR E-CID Positioning, NR DL-TDOA Positioning, NR
DL-AoD Positioning, and NR Multi-RTT Positioning the target device shall
ignore the unit field.
velocityRequest indicates whether velocity (or measurements related to
velocity) is requested (TRUE) or not (FALSE).
responseTimeNB
If the periodicalReporting IE or responseTime IE is included in
CommonIEsRequestLocationInformation, this field should not be included by the
location server and shall be ignored by the target device (if included).
timeNB indicates the maximum response time as measured
between receipt of the RequestLocationInformation and transmission of a
ProvideLocationInformation. If the unitNB field is absent, this is given as an
integer number of seconds between 1 and 512. If the unitNB field is present, the
maximum response time is given in units of 10-seconds, between 10 and 5120
seconds.
responseTimeEarlyFixNB indicates the maximum response
time as measured between receipt of the RequestLocationInformation and
transmission of a ProvideLocationInformation containing early location
measurements or an early location estimate. If the unitNB field is absent, this is
given as an integer number of seconds between 1 and 512. If the unitNB field is
present, the maximum response time is given in units of 10-seconds, between 10
and 5120 seconds. When this IE is included, a target should send a
ProvideLocationInformation (or more than one ProvideLocationInformation if
location information will not fit into a single message) containing early location
information according to the responseTimeEarlyFixNB IE and a subsequent
ProvideLocationInformation (or more than one ProvideLocationInformation if
location information will not fit into a single message) containing final location
information according to the timeNB IE. A target shall omit sending a
ProvideLocationInformation if the early location information is not available at
the expiration of the time value in the responseTimeEarlyFixNB IE. A server
should set the responseTimeEarlyFixNB IE to a value less than that for the timeNB
IE. A target shall ignore the responseTimeEarlyFixNB IE if its value is not less
than that for the timeNB IE.
unitNB indicates the unit of the timeNB and
responseTimeEarlyFixNB fields. Enumerated value ‘ten-second’ corresponds to
a resolution of 10 seconds. If this field is absent, the unit/resolution is 1 second.
horizontalAccuracyExt indicates the maximum horizontal error in the
location estimate at an indicated confidence level. The ‘accuracyExt’
corresponds to the encoded high accuracy uncertainty as defined in TS
23.032 [15] and ‘confidence’ corresponds to confidence as defined in TS 23.032
[15]. This field should not be included by the location server and shall be
ignored by the target device if the horizontalAccuracy field is included in QoS.
verticalAccuracyExt indicates the maximum vertical error in the
location estimate at an indicated confidence level and is only applicable when a
vertical coordinate is requested. The ‘accuracyExt’ corresponds to the encoded
high accuracy uncertainty as defined in TS 23.032 [15] and ‘confidence’
corresponds to confidence as defined in TS 23.032 [15]. This field should not
be included by the location server and shall be ignored by the target device if the
verticalAccuracy field is included in QoS.
minorLocQoS may indicate an additional QoS parameter set for each QoS
level when the target UE is allowed to satisfy the multiple QoS levels for an
obtained location estimate without an additional LPP signal from the LMF.
When this field is indicated, the target UE may report a location estimate and
accuracyLevel satisfying the highest QoS among multiple indicated QoS levels
(minorLocQoS indicates additional set of the QoS parameters per each QoS level
when the target UE is allowed to fulfil multiple QoS levels for the obtained
location estimate without further LPP signaling from LMF. When this field is
indicated, the target UE can report the location estimate with the accuracyLevel
of the highest QoS level fulfilled among the indicated multiple QoS levels).
QoS_param may indicate a parameter for each QoS level. This field may
include sub parameters such as horizontalAccuracyExt, verticalAccuracyExt,
verticalCoordinateRequest, and accuracyLevel. accuracyLevel indicates the
identification of each satisfied QoS level, and the order of the stringency level.
That is, “0” may mean the most preferred or stringent QoS level, and “1” may
represent the next or intermediate preferred/stringent QoS level (QoS_param
indicates the parameters per each QoS level. This field may have the following
sub parameters, horizontalAccuracyExt, verticalAccuracyExt,
verticalCoordinateRequest, and accuracyLevel. accuracyLevel indicates the
identification of each QoS level to be fulfilled, and the order of the stringency
level, i.e., ‘0’ means the most preferred or stringent QoS level, and ‘1’ means the
next or intermediate preferred/stringent QoS level, and so on).
All QoS requirements shall be obtained by the target device to the degree possible
but it is permitted to return a response that does not fulfill all QoS requirements
if some were not attainable. The single exception is time and timeNB which
shall always be fulfilled - even if that means not fulfilling other QoS
requirements.
A target device supporting NB-IoT access shall support the responseTimeNB IE.
A target device supporting HA GNSS shall support the HorizontalAccuracyExt,
VerticalAccuracyEx, and unit fields with enumerated value ‘ten-seconds’.
A target device supporting NB-IoT access and HA GNSS shall support the unitNB
field.

Issue 2: a Method in which responseTime is Included in an LPP Request Location Information Message

Opt 1. Single responseTime may be used. If Single responseTime is used, the response Time may be included in the common field as in the existing scheme. In the case of multiple QoSs, regardless of whether measurement is repeated, or whether to evaluate whether a location estimate as a result of measurement according to an order meets a QoS requirement, the UE only needs to report a location estimate and the highest satisfied QoS accuracy within responseTime when finally reporting same to the LMF.

UE operation: In the case where a single response time and multiple QoSs are given, the UE measures a given PRS, obtains a location estimate, and then determines which QoS level is satisfied. Whether additional measurement is necessary after a stringent QoS level is not satisfied depends on the UE implementation. In any case, the total time required to receive an LPP RequestLocationInformation message including a multi-QoS configuration and transmit an LPP ProvideLocationInformation message as a response needs to be smaller than the given response time.

(Opt 1. Single responseTime: if single response time is given, and multiple QoS is given, then it is up to UE for which stringent QoS requirement consume the time as a response time. Only requirement is the total response time consumed for all the stringent level is less than the given responseTime.

UE operation: when multiple QoS parameters (without responseTime) are given, and there is only single responseTime in QoS field above, UE does the measurement on the given PRS, and find the location estimate, and determine which QoS level is fulfilled. It is up to the UE implementation that whether additional measurement is necessary after the stringent QoS level is not fulfilled. Anyway, the total taken time from the receiving LPP ReuqestLocationInformation msg including multiQoS configuration, and to its response transmission LPP ProvideLocationInformation msg, should be less than the given responseTime.)

Opt 2. Separate responseTime per each QoS. This case may indicate a case where a response time is defined for each QoS and the LMF transfers the response time. The UE may comply with the response time given for each QoS, and perform any one of the following operations.
Measurement of a relevant reference signal
Deriving of a location estimate from a measurement result
Evaluation of whether the derived location estimate satisfies a given accuracy of a QoS and, when the accuracy is satisfied, reporting of a corresponding result and an accuracy indicator to the LMF

Obviously, the order of performing the above-described operations may be in the order from the highest accuracy level, the highest stringency level, or the highest preference level to the smallest.

(Each QoS class may have a required responseTime value. Signaling may be as follows (Each QoS class can also have the required responseTime value. Signaling could be as below)):

MultiQoS-r18 ::= SEQUENCE (SIZE (1..3)) OF QoS_param
QoS_param ::= SEQUENCE {

| | |
|---|---|
| Accuracylevel | INTEGER(0..2) |

| | |
|---|---|
| horizontalAccuracyExt-r15 | HorizontalAccuracyExt-r15 |

| | |
|---|---|
| OPTIONAL, | -- Need ON |

| | |
|---|---|
| verticalCoordinateRequest | BOOLEAN, |
| verticalAccuracyExt-r15 | VerticalAccuracyExt-r15 |

OPTIONAL, -- Need ON

| | |
|---|---|
| responseTime | ResponseTime |

}

In this case, a specification indicating that during this time, the UE needs to perform at least one of the following for an associated QoS is required (In this case, there should be a specification that within this time associated QoS, UE should do at least one from the followings):
Measurement of a location-related signal configured in LPP RequestLocationInformation (Measure the configured positioning related signal configured in LPP RequestLocationInformation)
Acquisition of a location estimate (Obtain the location estimate)
Evaluation of whether a location estimate result satisfies a relevant QoS accuracy (or QoS level) (Evaluate on whether the resulting location estimate is fulfilling the associated QoS accuracy (or QoS).

This operation is repeated for each QoS, and the execution order is from the highest stringency level (or preferred QoS or the highest accuracy) to the lowest (this operation is repeated for each QoS, and the order to be executed is the decreasing stringency level (or preferred QoS level)).

In stage 6, when the UE receives the LPP RequestLocationInformation message, the UE may, based on given assistance data, measure a DL PRS or a signal for each designated positioning method, and determine whether a location estimate satisfies the accuracies corresponding to the respective QoSs given in the previous stage. In this case, the UE may perform the determination in a sequential and/or conditional manner (e.g., when an accuracy requirement of the previous step is not satisfied, a next accuracy is determined) in a preference order or a stringency order.

In stage 7, depending on a result of the determination by the UE, the UE may include, in an LPP Provide Location Information message, information on the highest preference or the highest stringency level among satisfied QoSs of the given QoSs, and transfer the message to the LMF. If none of the given QoSs is satisfied, the UE may include an indicator indicating that no QoS is satisfied, in an LPP Provide Location Information message, or indicate an error in the positioning procedure within the message, and transfer the message to the LMF.

In stages 8 and 9, the LMF may transfer an indicator indicating an achieved QoS and a location estimate result value to the LCS client.

It should be noted that the configuration diagrams, illustrative diagrams of control/data signal transmission methods, and illustrative diagrams of operation procedures as illustrated in FIG. 1 to FIG. 8 are not intended to limit the scope of protection of the disclosure. That is, all the constituent elements, entities, or operation steps shown and described in FIG. 1 to FIG. 8 should not be construed as being essential elements for the implementation of the disclosure, and even when including only some of the elements, the disclosure may be implemented without impairing the true of the disclosure.

Methods disclosed in the claims or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1-15. (canceled)

16. A method performed by a terminal in a wireless communication system, the method comprising:
receiving, from a location management function (LMF) entity, a first message including information for positioning measurements for multiple quality of services (QoSs);
performing sequential measurements for the multiple QoSs, based on the first message; and
transmitting, to the LMF entity, a second message including a result of the sequential measurements,
wherein the information for positioning measurements includes at least one of accuracy values for the multiple QoSs or a response time of a measurement result.

17. The method of claim 16, wherein performing the sequential measurements for each of the multiple QoSs comprises:
performing a measurement of a first QoS among the multiple QoSs according to required levels of the accuracy values; and
in case that a measurement result of the first QoS does not satisfy an accuracy value for the first QoS, performing a measurement of a second QoS among the multiple QoSs,
wherein the sequential measurements are performed within the response time.

18. The method of claim 16, wherein the second message further includes information indicating a QoS satisfying the accuracy value.

19. The method of claim 16, wherein, in case that no QoS satisfies the accuracy value, the second message further includes information indicating that no QoS is satisfied or information indicating an error in a positioning procedure.

20. A method performed by a location management function (LMF) entity in a wireless communication system, the method comprising:
receiving, from a location services client (LCS) entity, a first message including information for positioning measurements for multiple quality of services (QoSs);
transmitting, to a terminal, a second message including the information for the positioning measurements, based on the first message; and
receiving, from the terminal, a third message including a result of sequential measurements of the multiple QoSs,
wherein the information for the positioning measurements includes at least one of accuracy values for the multiple QoSs or a response time of a measurement result.

21. The method of claim 20, wherein the sequential measurements are based on required levels of the accuracy values,
wherein, in case that a measurement result of a first QoS among the multiple QoSs does not satisfy an accuracy value for the first QoS, the third message includes a measurement result of a second QoS among the multiple QoSs, and
wherein the sequential measurements are performed within the response time.

22. The method of claim 20, wherein the third message further includes information indicating a QoS satisfying the accuracy value.

23. The method of claim 20, wherein, in case that no QoS satisfies the accuracy value, the third message further includes information indicating that no QoS is satisfied or information indicating an error in a positioning procedure.

24. A terminal comprising:
at least one transceiver;
at least one processor communicatively coupled to the at least one transceiver; and
at least one memory, communicatively coupled to the at least one processor, storing instructions executable by the at least one processor individually or in any combination to cause the terminal to:
receive, from a location management function (LMF) entity, a first message including information for positioning measurements for multiple quality of services (QoSs),
perform sequential measurements for the multiple QoSs, based on the first message, and
transmit, to the LMF entity, a second message including a result of the sequential measurements,
wherein the information for the positioning measurements includes at least one of accuracy values for the multiple QoSs or a response time of a measurement result.

25. The terminal of claim 24, wherein the instructions further cause the terminal to:
perform measurement of a first QoS among the multiple QoSs according to required levels of the accuracy values, and
in case that a measurement result of the first QoS does not satisfy an accuracy value for the first QoS, perform measurement of a second QoS among the multiple QoSs,
wherein the sequential measurements are performed within the response time.

26. The terminal of claim 24, wherein the second message further includes information indicating a QoS satisfying the accuracy value.

27. The method of claim 24, wherein, in case that no QoS satisfies the accuracy value, the second message further includes information indicating that no QoS is satisfied or information indicating an error in a positioning procedure.

28. A location management function (LMF) entity comprising:
at least one processor; and
at least one memory, communicatively coupled to the at least one processor, storing instructions executable by the at least one processor individually or in any combination to cause the LMF entity to:
receive, from a location services client (LCS) entity, a first message including information for positioning measurements for multiple quality of services (QoSs),
transmit, to a terminal, a second message including the information for the positioning measurements, based on the first message, and
receive, from the terminal, a third message including a result of sequential measurements of the multiple QoSs,
wherein the information for the positioning measurements includes at least one of accuracy values for the multiple QoSs or a response time of a measurement result.

29. The LMF entity of claim 28, wherein the sequential measurements are based on required levels of the accuracy values,
wherein, in case that a measurement result of a first QoS among the multiple QoSs does not satisfy an accuracy value for the first QoS, the third message includes a measurement result of a second QoS among the multiple QoSs, and
wherein the sequential measurements are performed within the response time.

30. The LMF entity of claim 28, wherein the third message further includes information indicating a QoS satisfying the accuracy value.

31. The LMF entity of claim 28, wherein, in case that no QoS satisfies the accuracy value, the third message further includes information indicating that no QoS is satisfied or information indicating an error in a positioning procedure.
